(19) United States
(12) Patent Application Publication
(10) Pub. No.: US 2010/0195455 A1
(43) Pub. Date: Aug. 5, 2010

(54) OPTICAL DISC APPARATUS, FOCUS ERROR SIGNAL ADJUSTMENT METHOD, PROGRAM, AND INTEGRATED CIRCUIT

(76) Inventors: Tooru Maruyama, Osaka (JP); Takeharu Yamamoto, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/668,764

(22) PCT Filed: May 25, 2009
(86) PCT No.: PCT/JP2009/002299

§ 371 Date: Jan. 12, 2010

(30) Foreign Application Priority Data
May 27, 2008 (JP) 2008-137593

(51) Int. Cl. G11B 7/00

(52) U.S. Cl. 369/44.23; G9B/7

(57) ABSTRACT

To adjust the symmetry of a focus error signal, the symmetry of the focus error signal needs to be measured during upward and downward driving of an objective lens, which is performed at every varying setting of a signal correction gain value of the focus error signal, and such adjustment takes a long time. An optical disc device (100) measures a focus error signal before differentiation at a local maximum point and a local minimum point of a focus error signal using a prior-to-differentiation FE measurement unit (50), and calculates the symmetry of the S-shape of a focus error signal using a symmetry calculation unit (51), and performs balance adjustment based on the calculation result. The device with this structure adjusts the symmetry of a focus error signal at a high speed by requiring an upward and downward operation to be performed only once.

### TECHNICAL FIELD

The present invention relates to an optical disc device that shortens the time taken to adjust the symmetry of a focus error signal (FE signal). In particular, the present invention relates to an optical disc device that calculates a signal correction value at a high speed using a positive FE signal and a negative FE signal.

### BACKGROUND ART

The structure and the operation of a conventional optical disc device will now be described with reference to FIGS. 10 and 11.

FIG. 10 is a schematic diagram showing the structure of a conventional optical disc device 900.

FIG. 11 is a graph showing the relationship between the gain value of a balance circuit 40 in the conventional optical disc device 900 and the symmetry of an FE signal (focus error signal).

Components of the optical disc device 900 that function to adjust the symmetry of a focus error signal (hereafter referred to as an “FE signal”) will first be described with reference to FIG. 10.

As shown in FIG. 10, the optical disc device 900 includes an optical head 10, a balance circuit 40, a differential circuit 41, an FE signal measurement unit 42, a symmetry calculation unit 43, an approximation unit 44, and a controller 45.

The FE signal indicates an error between a position on an information surface of an optical disc 1 and the position of the spot of a light beam, or specifically a tracking error occurring in a direction perpendicular to the disc surface (information surface) of the optical disc 1 (in the direction of the normal to the disc surface of the optical disc 1) (an error in the perpendicular direction occurring between the position on the information surface of the optical disc 1 and the position of the light beam spot).

The optical head 10 is mainly composed of a laser light source 30, a beam splitter 31, an objective lens 32, a focus actuator 33, and a light receiving unit 34.

The laser light source 30 emits a light beam having a predetermined power toward the optical disc 1. The emitted light beam passes through the beam splitter 31, and then passes through the objective lens 32 to converge on the information surface of the optical disc 1. A light beam reflected on the optical disc 1 is further reflected by the beam splitter 31 to enter the light receiving unit 34.

The light receiving unit 34 converts the received light beam to an electric signal, and outputs, to the balance circuit 40 and the differential circuit 41, the signal as a positive FE signal and a negative FE signal.

The differential circuit 41 generates an FE signal based on the positive FE signal, which is output from the light receiving unit 34, and on a signal obtained by the balance circuit 40 performing predetermined gain correction of the negative FE signal, which is output from the light receiving unit 34. The differential circuit 41 outputs the generated FE signal to the FE signal measurement unit 42.

The controller 45 sets a plurality of different predetermined gain values to be used by the balance circuit 40. The controller 45 generates, for each different gain value setting, a focus drive command for driving the objective lens 32 upward and downward with respect to the optical disc 1. The controller 45 transmits the generated focus drive command to the focus actuator 33.

The focus actuator 33 drives the objective lens 32 based on the focus drive command output from the controller. As the objective lens 32 is driven in this manner, the focus of the light beam, which has converged after passing through the objective lens 32, passes through the surface and the information surface of the optical disc 1. The FE signal output from the differential circuit 41 shows an S-shaped waveform (this S-shaped waveform is hereafter referred to as the “S-shape of an FE signal”) in an area around which the focus of the light beam passes through the surface or the information surface of the optical disc 1.

The FE signal measurement unit 42 measures the level of the S-shape of the FE signal (the signal level of the FE signal showing an S-shaped waveform) output from the differential circuit 41 during upward and downward driving of the objective lens 32, which is performed based on each varying gain value setting of the balance circuit 40 performed by the controller 45.

The symmetry calculation unit 43 calculates the symmetry of the S-shape of the FE signal (the symmetry of the signal level of the FE signal showing an S-shaped waveform) based on the level of the S-shape of the FE signal measured by the FE signal measurement unit 42.

The controller 45 further drives the objective lens 32 to move upward and downward using the focus actuator 33 based on each of the predetermined number of gain value settings of the balance circuit 40. Subsequently, the controller 45 transmits a command for performing straight-line approximation to the approximation unit 44.

The approximation unit 44 receives a command from the controller 45, and calculates using straight-line approximation a gain value of the balance circuit 40 that causes the symmetry of the S-shape of the FE signal to be substantially zero based on an output from the symmetry calculation unit 43 at each gain value setting of the balance circuit 40. The approximation unit 44 then sets the calculated gain value to be used by the balance circuit 40. The symmetry of the S-shape (S-shape symmetry) of the FE signal can be obtained using, for example, a positive-side amplitude A of the FE signal and a negative-side amplitude B of the FE signal shown in FIG. 7 as the following:

S-shape symmetry=(A−B)/(A+B).

The S-shape symmetry of the FE signal may alternatively be determined using other physical quantities, such as the absolute values of the amplitude values A and B, or a physical quantity determined based on, for example, a difference between the amplitude values A and B or the ratio of the amplitude values A and B.

### Operation for Adjusting the Symmetry of FE Signal

The operation of the conventional optical disc device 900 for adjusting the symmetry of the FE signal will now be described with reference to FIG. 11.

FIG. 11 shows the characteristic of the symmetry of the S-shape of the FE signal as a function of the gain value of the balance circuit 40 and an approximated straight line representing the characteristic. In FIG. 11, the horizontal axis indicates the gain value of the balance circuit 40, and the vertical axis indicates the symmetry of the S-shape of the FE signal.

The controller 45 sets a gain value G1 to be used by the balance circuit 40, and drives the objective lens 32 to move upward and downward with respect to the optical disc 1. The controller 45 then calculates a symmetry value SY1 of the resulting FE signal.

The controller 45 repeats the above operation using gain values G2, G3, G4, and G5 to calculate symmetry values SY2, SY3, SY4, and SY5 of the resulting FE signal. The gain values G1, G2, G3, G4, and G5 and the symmetry values SY1, SY2, SY3, SY4, and SY5 have the relationship (characteristic) shown in FIG. 11.

The optical disc device 900 obtains an approximated straight line representing the characteristic shown in FIG. 11 by straight-line approximation, and uses the approximated straight line to calculate a gain value G6 of the balance circuit 40 that causes the symmetry of the S-shape of the FE signal to be substantially zero. The optical disc device 900 then sets the calculated gain value G6 to be used by the balance circuit 40.

Patent Citation 1: Japanese Unexamined Patent Publication No. H8-212567

### DISCLOSURE OF INVENTION

### Technical Problem

The conventional optical disc device 900, however, needs to drive the objective lens 32 upward and downward for every gain value setting of the balance circuit 40 to adjust the symmetry of an FE signal, and such symmetry adjustment of an FE signal takes a long time.

To solve the above problem, it is an object of the present invention to provide an optical disc device, a focus error signal adjusting method, a program, and an integrated circuit that enable the symmetry (symmetry of the S-shape) of an FE signal to be adjusted with a high precision by requiring the operation of driving an objective lens upward and downward to be performed less number of times.

### Technical Solution

A first aspect of the present invention provides an optical disc device that records and/or reads on an optical disc having an information surface. The device includes an illumination unit, a converging unit, a focus drive unit, a light receiving unit, a measurement unit, a signal correction unit, a focus error signal generation unit, and a signal ratio calculation unit.

The illumination unit emits a light beam to the optical disc. The converging unit converges the light beam emitted from the illumination unit. The focus drive unit drives the converging unit in a manner to move a spot of the light beam that has been converged by the converging unit in a direction perpendicular to a disc surface of the optical disc. The light receiving unit has a plurality of divisional detectors, and receives reflected light from the optical disc using the plurality of divisional detectors and obtains, as a positive FE signal and a negative FE signal, an electric signal corresponding to an amount of the received light. The measurement unit measures a signal level of each of the positive FE signal and the negative FE signal obtained by the light receiving unit. The signal correction unit corrects the signal level of at least one of the positive FE signal and the negative FE signal by multiplying the at least one of the positive FE signal and the negative FE signal by a predetermined gain value. The focus error signal generation unit generates a focus error signal based on an output from the signal correction unit, and outputs the generated focus error signal. The signal ratio calculation unit obtains, based on an output from the measurement unit, the predetermined gain value by which the at least one of the positive FE signal and the negative FE signal is to be multiplied in a manner that the predetermined gain value causes an absolute value of a local maximum value of the focus error signal to be equal to an absolute value of a local minimum value of the focus error signal.

The signal correction unit corrects the signal level of the at least one of the positive FE signal and the negative FE signal based on the predetermined gain value obtained by the signal ratio calculation unit.

The positive FE signal and the negative FE signal are, for example, signals corresponding to a total amount of light received by two diagonally arranged detectors, among the four divisional detectors included in the light receiving unit. More specifically, when the four divisional detectors receive light amounts A, B, C, and D, and the detectors receiving the light amounts A and D are arranged on one diagonal line and the detectors receiving the light amounts B and C are arranged on the other diagonal line, the positive FE signal may correspond to (B+C), whereas the negative FE signal may correspond to (A+D). This is a mere example, and the present invention should not be limited to this structure.

The term “be equal” intends to cover the case of being substantially equal, and permits errors, such as a measurement error and a design error.

In this optical disc device, the measurement unit measures the signal level of each of the positive FE signal and the negative FE signal obtained by the light receiving unit, and the signal ratio calculation unit obtains the predetermined gain value that causes the absolute value of the local maximum value of the focus error signal to be equal to the absolute value of the local minimum value of the focus error signal, and the signal correction unit corrects the signal level of at least one of the positive FE signal and the negative FE signal using the obtained gain value. The optical disc device with this structure adjusts the symmetry (symmetry of the S-shape) of an FE signal with a high precision by requiring the spot of the light beam to be driven using the focus drive unit less number of times.

The optical disc device adjusts the signal symmetry at a high speed by requiring a focus error signal obtained before differentiation to be measured only one time.

A second aspect of the present invention provides the optical disc device of the first aspect of the present invention in which the signal ratio calculation unit obtains the predetermined gain value based on an output from the measurement unit at a point where a signal level of the focus error signal is at an extremum when the spot of the light beam is around a selected information surface of the optical disc or at a point where a signal level of each of the positive FE signal and the negative FE signal is at an extremum when the spot of the light beam is around a selected information surface of the optical disc.

This optical disc device obtains (calculates) the predetermined gain based on

(1) the extremum point of the signal level of the focus error signal when the spot of the light beam is around a selected information surface of the optical disc, or

(2) the extremum point of the signal level of each of the positive FE signal and the negative FE signal when the spot of the light beam is around a selected information surface of the optical disc.

This optical disc device adjusts the symmetry of the S-shape of a focus error signal in an appropriate manner, and thus executes focus control in a stable manner on a selected information surface of the optical disc.

The “extremum” intends to include a largest value, a smallest value, a local maximum value, and a local minimum value.

A third aspect of the present invention provides the optical disc device of the second aspect of the present invention in which the device further includes a focus control unit and a focusing unit.

The focus control unit controls the spot of the light beam to be positioned on an information surface of the optical disc in accordance with a signal output from the focus error signal generation unit. The focusing unit moves the spot of the light beam in the direction perpendicular to the disc surface of the optical disc using the focus drive unit, and activates a control operation performed by the focus control unit when a position of the spot of the light beam agrees with a position on a selected information surface of the optical disc. The signal ratio calculation unit obtains the predetermined gain value to be used by the signal correction unit based on an output from the measurement unit at least once before the focusing unit activates the control operation performed by the focus control unit.

This optical disc device obtains (calculates) the predetermined gain value to be used by the signal correction unit based on an output from the measurement unit at least once before the focus control unit is activated by the signal ratio calculation unit, and thus performs focusing in a stable manner on a selected information surface of the optical disc.

A fourth aspect of the present invention provides the optical disc device of the second aspect of the pr esent invention in which the device further includes a spherical aberration correction unit that corrects a spherical aberration of the spot of the light beam on a selected information surface of the optical disc. The signal ratio calculation unit obtains the predetermined gain value to be used by the signal correction unit based on an output from the measurement unit after the spherical aberration is corrected by the spherical aberration correction unit.

This optical disc device obtains (calculates) the predetermined gain value to be used by the signal correction unit based on an output from the measurement unit after the spherical aberration correction, and thus effectively eliminates an influence of symmetry deviation of a focus error signal, which would otherwise be caused by spherical aberration. As a result, the optical disc device adjusts the symmetry of the S-shape of a focus error signal in a more appropriate manner, and performs focus control in a more stable manner on a selected information surface of the optical disc.

A fifth aspect of the present invention provides the optical disc device of the fourth aspect of the present invention in which the device further includes a focus control unit and a focusing unit.

The focus control unit controls the spot of the light beam to be positioned on an information surface of the optical disc in accordance with a signal output from the focus error signal generation unit. The focusing unit moves the spot of the light beam in a direction perpendicular to the disc surface of the optical disc using the focus drive unit, and activates a control operation performed by the focus control unit when a position of the spot of the light beam agrees with a position on a selected information surface of the optical disc. The signal ratio calculation unit obtains the predetermined gain value to be used by the signal correction unit based on an output from the measurement unit when the spot of the light beam is moved toward the optical disc using the focusing unit. The focusing unit executes focus control using the focus control unit in a manner that the spot of the light beam is positioned on a selected information surface of the optical disc after the predetermined gain value is obtained by the signal ratio calculation unit.

In this optical disc device, the signal ratio calculation unit obtains (calculates) the predetermined gain value to be used by the signal correction unit based on an output from the measurement unit when the spot of the light beam is moved toward the optical disc. The optical disc device adjusts the symmetry of a focus error signal by sharing the processing time for focusing, and thus shortens the activation time.

A sixth aspect of the present invention provides the optical disc device of the fourth aspect of the present invention in which the device further includes a disc determination unit that performs an operation of moving the spot of the light beam toward the optical disc and an operation of moving the spot of the light beam away from the optical disc using the focus drive unit to determine a type of the optical disc mounted on the device.

The signal ratio calculation unit obtains the predetermined gain value to be used by the signal correction unit based on an output from the measurement unit during at least one of the operation of moving the spot of the light beam toward the optical disc and the operation of moving the spot of the light beam away from the optical disc performed by the disc determination unit.

This optical disc device adjusts the symmetry of a focus error signal by sharing the processing time for disc determination, and thus shortens the activation time.

A seventh aspect of the present invention provides the optical disc device of the sixth aspect of the present invention in which the device further includes a signal ratio optimization unit that obtains, as a first gain value, the predetermined gain value obtained by the signal ratio calculation unit during the operation of moving the spot of the light beam toward the optical disc, and obtains, as a second gain value, the predetermined gain value obtained by the signal ratio calculation unit during the operation of moving the spot of the light beam away from the optical disc, and obtains the predetermined gain value to be used by the signal correction unit based on the first gain value and the second gain value.

This optical disc device obtains (calculates) the predetermined gain value to be used by the signal correction unit based on the first gain value and the second gain value, and thus improves the precision of symmetry adjustment of a focus error signal further.

It is preferable that the predetermined gain value obtained by the signal ratio optimization unit be set to satisfy the following:

−10%≦(S-shape symmetry)≦10%

when the symmetry of the S-shape of an FE signal (S-shape symmetry) is written as

S-shape symmetry=(A−B)/(A+B).

It is more preferable that the predetermined gain value be set to satisfy the following:

−5%≦(S-shape symmetry)≦5%.

An eighth aspect of the present invention provides the optical disc device of the first aspect of the present invention in which when the optical disc has a plurality of information surfaces, the signal ratio calculation unit obtains, for each of all the information surfaces, the predetermined gain value to be used by the signal correction unit based on a signal output from the measurement unit at a point where a signal level of the focus error signal is at an extremum when the spot of the light beam is around each information surface of the optical disc or at a point where a signal level of each of the positive FE signal and the negative FE signal is at an extremum when the spot of the light beam is around each information surface of the optical disc.

This optical disc device calculates a gain value for each of all the information surfaces when the optical disc has a plurality of information surfaces, and adjusts the symmetry of the S-shape of an FE signal on each of all the information surfaces in an appropriate manner. As a result, the optical disc device executes focus control in a stable manner even when the optical disc has a plurality of information surfaces.

A ninth aspect of the present invention provides the optical disc device of the eighth aspect of the present invention in which the device further includes a focus control unit and a focusing unit.

The focus control unit controls the spot of the light beam to be positioned on an information surface of the optical disc in accordance with a signal output from the focus error signal generation unit. The focusing unit moves the spot of the light beam in the direction perpendicular to the disc surface of the optical disc using the focus drive unit, and activates a control operation performed by the focus control unit when a position of the spot of the light beam agrees with a position on a selected information surface of the optical disc. The signal ratio calculation unit obtains the predetermined gain value to be used by the signal correction unit based on an output from the measurement unit at least once before the focusing unit activates the control operation performed by the focus control unit.

This optical disc device performs focusing in a stable manner on each of all the information surfaces, and further enables a focus jump to a selected information surface to be performed in a stable manner.

A tenth aspect of the present invention provides the optical disc device of the eighth aspect of the present invention in which the device further includes a focus control unit and a focusing unit.

The focus control unit controls the spot of the light beam to be positioned on an information surface of the optical disc in accordance with a signal output from the focus error signal generation unit. The focusing unit moves the spot of the light beam in the direction perpendicular to the disc surface of the optical disc using the focus drive unit, and activates a control operation performed by the focus control unit when a position of the spot of the light beam agrees with a position on a selected information surface of the optical disc.

The signal ratio calculation unit obtains the predetermined gain value to be used by the signal correction unit based on an output from the measurement unit when the spot of the light beam is moved toward the optical disc using the focusing unit. The focusing unit executes focus control using the focus control unit in a manner that the spot of the light beam is positioned on a selected information surface of the optical disc after the predetermined gain value is obtained by the signal ratio calculation unit.

This optical disc device adjusts the symmetry of a focus error signal on each of all the information surfaces by sharing the processing time for focusing, and thus shortens the activation time.

An eleventh aspect of the present invention provides the optical disc device of the eighth aspect of the present invention in which the device further includes a disc determination unit that performs an operation of moving the spot of the light beam toward the optical disc and an operation of moving the spot of the light beam away from the optical disc using the focus drive unit to determine a type of the optical disc mounted on the optical disc device.

The signal ratio calculation unit obtains the predetermined gain value to be used by the signal correction unit based on an output from the measurement unit during at least one of the operation of moving the spot of the light beam toward the optical disc and the operation of moving the spot of the light beam away from the optical disc performed by the disc determination unit.

This optical disc device adjusts the symmetry of a focus error signal on each of all the information surfaces by sharing the processing time for disc determination, and thus shortens the activation time.

A twelfth aspect of the present invention provides the optical disc device of the eleventh aspect of the present invention in which the device further includes a signal ratio optimization unit that obtains, as a first gain value, the predetermined gain value obtained by the signal ratio calculation unit during the operation of moving the spot of the light beam toward the optical disc, and obtains, as a second gain value, the predetermined gain value obtained by the signal ratio calculation unit during the operation of moving the spot of the light beam away from the optical disc, and obtains the predetermined gain value to be used by the signal correction unit based on the first gain value and the second gain value.

This optical disc device improves the precision of symmetry adjustment of a focus error signal on all the information surfaces.

A thirteenth aspect of the present invention provides the optical disc device of the eighth aspect of the present invention in which the device further includes a spherical aberration correction unit that corrects a spherical aberration of the spot of the light beam during at least one of the operation of moving the spot of the light beam toward the optical disc and the operation of moving the spot of the light beam away from the optical disc performed by the focus drive unit when the spot of the light beam passes through each of all the information surfaces of the optical disc. The spherical aberration correction is performed in parallel with the operation performed by the focus drive unit in a manner to reduce the spherical aberration of the spot of the light beam to substantially zero on a selected information surface through which the spot of the light beam passes.

This optical disc device adjusts the symmetry of the S-shape of an FE signal in parallel with the spherical aberration correction.

The device eliminates an influence of symmetry deviation of a focus error signal, which would otherwise be caused by spherical aberration on all the information surfaces, and thus shortens the time taken for such signal symmetry adjustment.

A fourteen aspect of the present invention provides the optical disc device of the eighth aspect of the present invention in which the device further includes a spherical aberration correction unit and an each-layer signal ratio calculation unit.

The spherical aberration correction unit corrects a spherical aberration of the spot of the light beam on a selected information surface of the optical disc. The each-layer signal ratio calculation unit performs processing of first activating an operation of the spherical aberration correction unit on a selected information surface of the optical disc and then activating an operation of obtaining the predetermined gain value performed by the signal ratio calculation unit during at least one of the operation of moving the spot of the light beam toward the optical disc and the operation of moving the spot of the light beam away from the optical disc performed by the focus drive unit. The each-layer signal ratio calculation unit performs the processing for each of all the information surfaces of the optical disc.

This optical disc device adjusts the symmetry of the S-shape of an FE signal after performing spherical aberration correction on each information surface (information layer). This optical disc device precisely eliminates an influence of symmetry deviation of a focus error signal, which would otherwise be caused by spherical aberration on all the information surfaces.

A fifteenth aspect of the present invention provides the optical disc device of the first aspect of the present invention that records and/or reads on an optical disc having a plurality of information surfaces. The device further includes a plurality-of-information-surface signal ratio calculation unit that calculates, as the predetermined gain value to be used by the signal correction unit, a common gain value that is used commonly for the plurality of information surfaces of the optical disc.

The signal ratio calculation unit obtains a plurality of predetermined gain values for the plurality of information surfaces. The plurality-of-information-surface signal ratio calculation unit obtains the common gain value based on the plurality of predetermined gain values for the plurality of information surfaces that are obtained by the signal ratio calculation unit.

In this optical disc device, the signal ratio calculation unit calculates a plurality of predetermined gain values for the plurality of information surfaces, and the plurality-of-information-surface signal ratio calculation unit obtains (calculates) a gain value commonly used for the plurality of information surfaces based on the plurality of predetermined gain values for the plurality of information surfaces that are obtained by the signal ratio calculation unit. The optical disc device thus executes focus control in a stable manner over a plurality of information surfaces, and improves the stability of focus control before and after a focus jump.

The “common gain value” may be, for example, an average of the plurality of predetermined gain values calculated for the plurality of information surfaces of the optical disc.

A sixteenth aspect of the present invention provides the optical disc device of the fifteenth aspect of the present invention in which the device further includes a focus control unit and a focusing unit.

The focus control unit controls the spot of the light beam to be positioned on an information surface of the optical disc in accordance with a signal output from the focus error signal generation unit. The focusing unit moves the spot of the light beam in a direction perpendicular to the disc surface of the optical disc using the focus drive unit, and activates a control operation performed by the focus control unit when the spot of the light beam is positioned on a selected information surface of the optical disc.

The plurality-of-information-surface signal ratio calculation unit obtains the common gain value based on an output from the measurement unit at least once before the focusing unit activates the control operation performed by the focus control unit.

This optical disc device performs focusing in a stable manner using a focus error signal that enables focus control to be executed in a stable manner over a plurality of information surfaces.

A seventeenth aspect of the present invention provides a focus error signal adjusting method used in an optical disc device that records and/or reads on an optical disc having an information surface and includes an illumination unit that emits a light beam to the optical disc, a converging unit that converges the light beam emitted from the illumination unit, a focus drive unit that drives the converging unit in a manner to move a spot of the light beam that has been converged by the converging unit in a direction perpendicular to a disc surface of the optical disc, and a light receiving unit that includes a plurality of divisional detectors and receives reflected light from the optical disc using the plurality of divisional detectors and obtains, as a positive FE signal and a negative FE signal, an electric signal corresponding to an amount of the received light. The focus error signal adjusting method includes a measurement process, a signal correction process, a focus error signal generation process, and a signal ratio calculation process.

In the measurement process, a signal level of each of the positive FE signal and the negative FE signal obtained by the light receiving unit is measured. In the signal correction process, the signal level of at least one of the positive FE signal and the negative FE signal is corrected by multiplying the at least one of the positive FE signal and the negative FE signal by a predetermined gain value. In the focus error signal generation process, a focus error signal is generated based on an output from the signal correction unit, and the generated focus error signal is output. In the signal ratio calculation process, the predetermined gain value by which the at least one of the positive FE signal and the negative FE signal is to be multiplied is obtained based on an output in the measurement process in a manner that the predetermined gain value causes an absolute value of a local maximum value of the focus error signal to be equal to an absolute value of a local minimum value of the focus error signal.

In the signal correction process, the signal level of the at least one of the positive FE signal and the negative FE signal is corrected based on the predetermined gain value obtained in the signal ratio calculation process.

The focus error signal adjusting method has the same advantageous effects as the optical disc device of the first aspect of the present invention.

An eighteenth aspect of the present invention provides a program enabling a computer to implement a focus error signal adjusting method used in an optical disc device that records and/or reads on an optical disc having an information surface and includes an illumination unit that emits a light beam to the optical disc, a converging unit that converges the light beam emitted from the illumination unit, a focus drive unit that drives the converging unit in a manner to move a spot of the light beam that has been converged by the converging unit in a direction perpendicular to a disc surface of the optical disc, and a light receiving unit that includes a plurality of divisional detectors and receives reflected light from the optical disc using the plurality of divisional detectors and obtains, as a positive FE signal and a negative FE signal, an electric signal corresponding to an amount of the received light. The focus error signal adjusting method includes a measurement process, a signal correction process, a focus error signal generation process, and a signal ratio calculation process.

In the measurement process, a signal level of each of the positive FE signal and the negative FE signal obtained by the light receiving unit is measured. In the signal correction process, the signal level of at least one of the positive FE signal and the negative FE signal is corrected by multiplying the at least one of the positive FE signal and the negative FE signal by a predetermined gain value. In the focus error signal generation process, a focus error signal is generated based on an output from the signal correction unit, and the generated focus error signal is output. In the signal ratio calculation process, the predetermined gain value by which the at least one of the positive FE signal and the negative FE signal is to be multiplied is obtained based on an output in the measurement process in a manner that the predetermined gain value causes an absolute value of a local maximum value of the focus error signal to be equal to an absolute value of a local minimum value of the focus error signal.

In the signal correction process, the signal level of the at least one of the positive FE signal and the negative FE signal is corrected based on the predetermined gain value obtained in the signal ratio calculation process.

The program has the same advantageous effects as the optical disc device of the first aspect of the present invention.

A nineteen aspect of the present invention provides an integrated circuit used in an optical disc device that records and/or reads on an optical disc having an information surface and includes an illumination unit that emits a light beam to the optical disc, a converging unit that converges the light beam emitted from the illumination unit, a focus drive unit that drives the converging unit in a manner to move a spot of the light beam that has been converged by the converging unit in a direction perpendicular to a disc surface of the optical disc, and a light receiving unit that includes a plurality of divisional detectors and receives reflected light from the optical disc using the plurality of divisional detectors and obtains, as a positive FE signal and a negative FE signal, an electric signal corresponding to an amount of the received light. The integrated circuit includes a measurement unit, a signal correction unit, a focus error signal generation unit, and a signal ratio calculation unit.

The measurement unit measures a signal level of each of the positive FE signal and the negative FE signal obtained by the light receiving unit. The signal correction unit corrects the signal level of at least one of the positive FE signal and the negative FE signal by multiplying the at least one of the positive FE signal and the negative FE signal by a predetermined gain value. The focus error signal generation unit generates a focus error signal based on an output from the signal correction unit, and outputs the generated focus error signal. The signal ratio calculation unit obtains, based on an output from the measurement unit, the predetermined gain value by which the at least one of the positive FE signal and the negative FE signal is to be multiplied in a manner that the predetermined gain value causes an absolute value of a local maximum value of the focus error signal to be equal to an absolute value of a local minimum value of the focus error signal,

The signal correction unit corrects the signal level of the at least one of the positive FE signal and the negative FE signal based on the predetermined gain value obtained by the signal ratio calculation unit.

The integrated circuit has the same advantageous effects as the optical disc device of the first aspect of the present invention.

### ADVANTAGEOUS EFFECTS

The optical disc device, the focus error signal adjusting method, the program, and the integrated circuit of the present invention enable the symmetry (symmetry of the S-shape) of an FE signal to be adjusted with a high precision by requiring the operation of driving an objective lens upward and downward to be performed less number of times.

### BRIEF DESCRIPTION OF DRAWINGS

FIG. 1 is a block diagram of a device according to a first embodiment of the present invention.

FIG. 2A is a graph showing a signal indicating the position of an objective lens during focusing operation performed by a focusing unit in a second embodiment of the present invention, where the horizontal axis indicates time and the vertical axis indicates the signal level, FIG. 2B is a graph showing an FE signal during focusing operation performed by the focusing unit in the second embodiment, where the horizontal axis indicates time and the vertical axis indicates the signal level, FIG. 2C is a graph showing a positive FE signal during focusing operation performed by the focusing unit in the second embodiment, where the horizontal axis indicates time and the vertical axis indicates the signal level, and FIG. 2D is a graph showing a negative FE signal during focusing operation performed by the focusing unit in the second embodiment, where the horizontal axis indicates time and the vertical axis indicates the signal level.

FIG. 3 is a block diagram of a device according to the second embodiment.

FIG. 4A is a graph showing a signal indicating the position of an objective lens during disc determination performed by a disc determination control unit in the second embodiment, where the horizontal axis indicates time and the vertical axis indicates the signal level, FIG. 4B is a graph showing a signal indicating a correction level of a spherical aberration correction unit during disc determination performed by the disc determination control unit in the second embodiment, where the horizontal axis indicates time and the vertical axis indicates the signal level, FIG. 4C is a graph showing an FE signal during disc determination performed by the disc determination control unit in the second embodiment, where the horizontal axis indicates time and the vertical axis indicates the signal level, FIG. 4D is a graph showing a positive FE signal during disc determination performed by the disc determination control unit in the second embodiment, where the horizontal axis indicates time and the vertical axis indicates the signal level, and FIG. 4E is a graph showing a negative FE signal during disc determination performed by the disc determination control unit in the second embodiment, where the horizontal axis indicates time and the vertical axis indicates the signal level.

FIG. 5 is a block diagram of a device according to a third embodiment of the present invention.

FIG. 6A is a graph showing a signal indicating the position of an objective lens during focusing operation performed by a focusing unit in the third embodiment, where the horizontal axis indicates time and the vertical axis indicates the signal level, FIG. 6B is a graph showing an FE signal during focusing operation performed by the focusing unit in the third embodiment, where the horizontal axis indicates time and the vertical axis indicates the signal level, FIG. 6C is a graph showing a positive FE signal during focusing operation performed by the focusing unit in the third embodiment, where the horizontal axis indicates time and the vertical axis indicates the signal level, and FIG. 6D is a graph showing a negative FE signal during focusing operation performed by the focusing unit in the third embodiment, where the horizontal axis indicates time and the vertical axis indicates the signal level.

FIG. 7 is a diagram describing the symmetry of the S-shape of an FE signal.

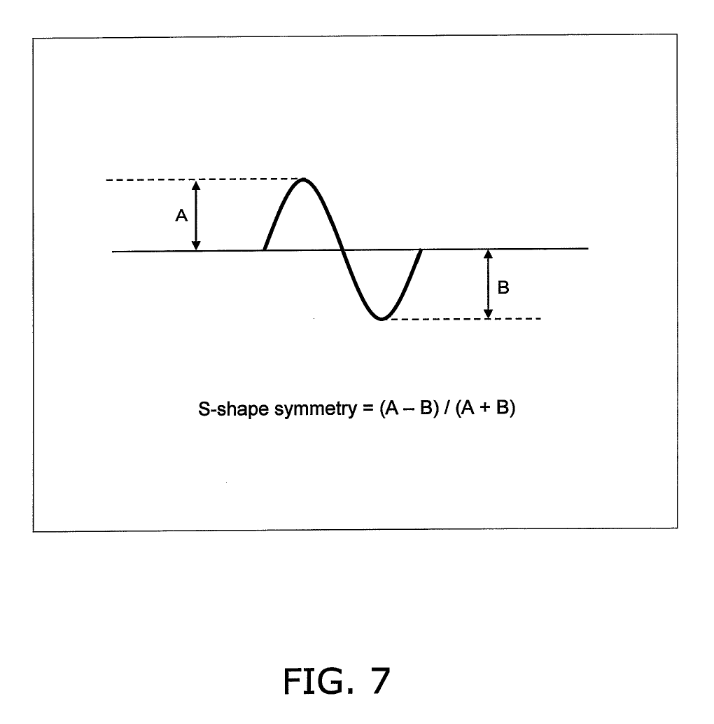

FIG. 8 is a schematic diagram partially showing the structure of an optical disc device according to another embodiment of the present invention.

FIGS. 9A to 9F are signal waveform diagrams describing the operation of the optical disc device according to the other embodiment.

FIG. 10 is a block diagram of a device according to a conventional example.

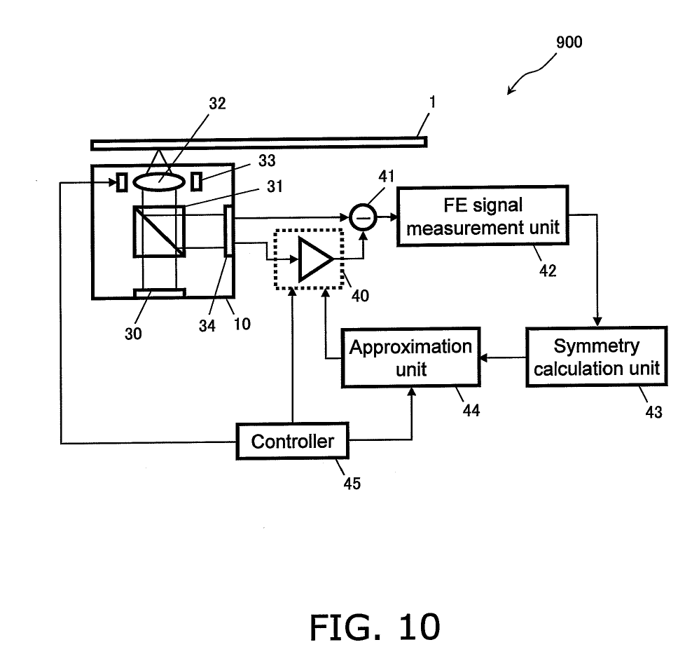

FIG. 11 is a graph showing the characteristic of the symmetry of the S-shape of an FE signal as a function of the gain value of a balance circuit and an approximated straight line representing the characteristic in the conventional example, where the horizontal axis indicates the gain value of the balance circuit and the vertical axis indicates the symmetry of the S-shape of the FE signal.

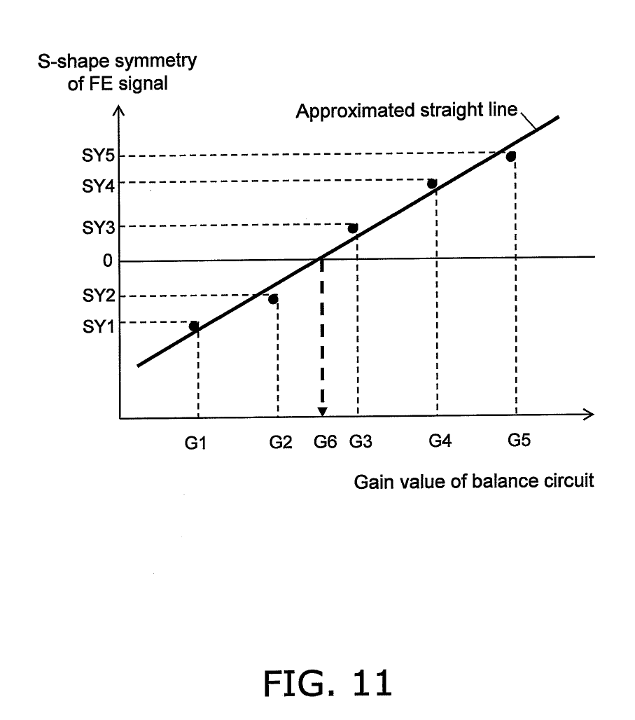

### EXPLANATION OF REFERENCE

100, 200, 300, 900 optical disc device
1 optical disc
10 optical head
20 optical head
30 laser light source
31 beam splitter
32 objective lens
33 focus actuator
34, 340, 341, 342 light receiving unit
35 spherical aberration correction unit
40, 40A, 40B balance circuit
41, 41A, 41B differential circuit
42 FE signal measurement unit
43 symmetry calculation unit
44 approximation unit
45 controller
50, 50A prior-to-differentiation FE measurement unit
51, 51A symmetry calculation unit
52 spherical aberration control unit
53 focus drive output switch
54 focus filter
55 focusing unit
56 controller
60 symmetry calculation unit
61 temporary memory
62 each-layer-average obtaining unit
63 disc determination control unit
64 controller
70 controller
71 plurality-of-layer-average obtaining unit

### BEST MODE FOR CARRYING OUT THE INVENTION

Embodiments of the present invention will now be described.

### First Embodiment

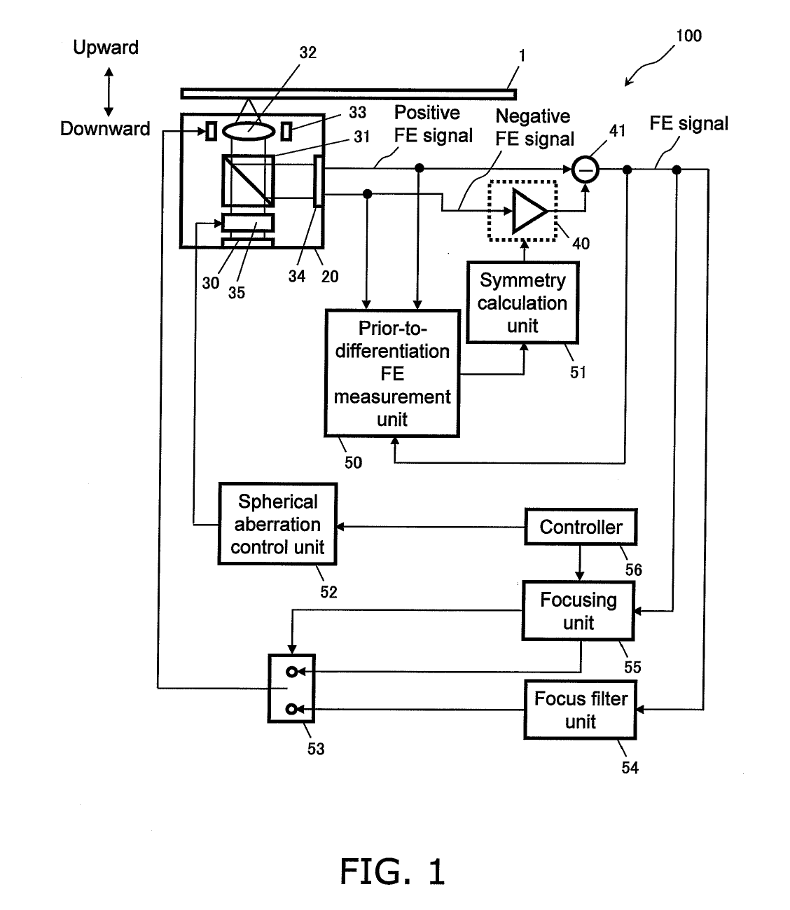

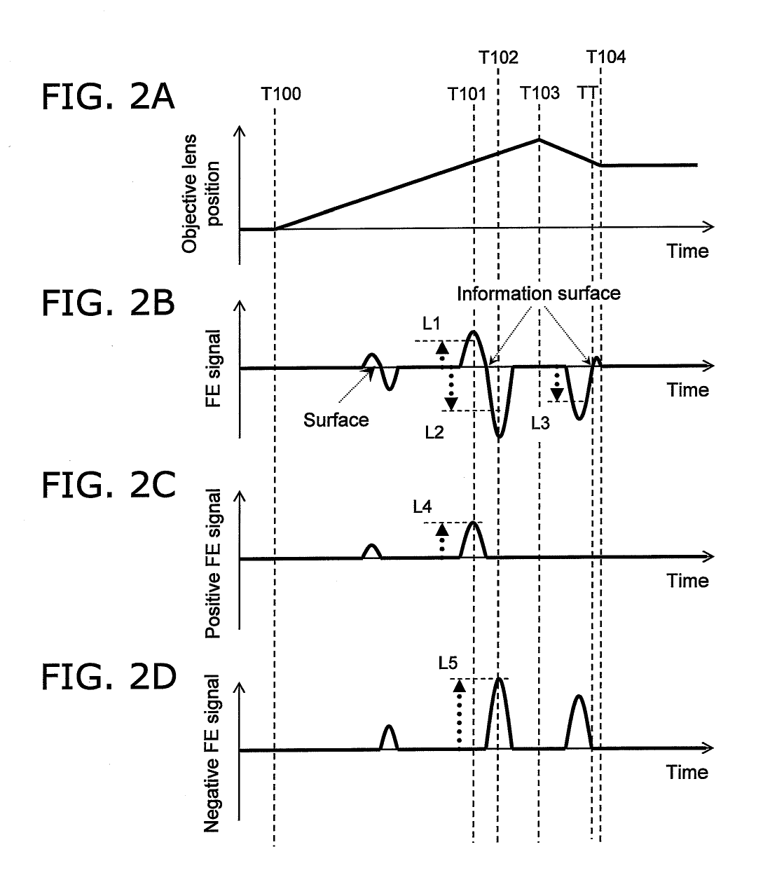

A first embodiment of the present invention will now be described with reference to FIGS. 1 and 2A to 2D.

### 1.1 Structure of the Optical Disc Device

FIG. 1 is a block diagram schematically showing the structure of an optical disc device 100 according to the present embodiment.

As shown in FIG. 1, the optical disc device 100, which records and reads information on an optical disc 1, includes an optical head 20, a balance adjustment unit (balance circuit) 40, a subtraction unit (differential circuit) 41, a prior-to-differentiation FE measurement unit 50, and a symmetry calculation unit 51. The optical disc device 100 further includes a controller 56, a spherical aberration control unit 52, a focusing unit 55, a focus filter unit 54, and a switch unit (focus drive output switch) 53.

The optical head 20 includes a laser light source 30, a beam splitter 31, an objective lens 32, a focus actuator 33, a light receiving unit 34, and a spherical aberration correction unit 35.

The laser light source 30, the beam splitter 31, the objective lens 32, the focus actuator 33, the light receiving unit 34, the balance adjustment unit (balance circuit) 40, and the subtraction unit (differential circuit) 41 have functions equivalent to the functions of the corresponding components included in the conventional optical disc device 900, and will not be described in detail.

The optical disc device 100 differs from the device of the conventional technique (optical disc device 900) in that the device 100 uses the optical head 20, the spherical aberration correction unit 35, the prior-to-differentiation FE measurement unit 50, the symmetry calculation unit 51, the spherical aberration control unit 52, the switch unit (focus drive output switch) 53, the focus filter unit 54, the focusing unit 55, and the controller 56, and the device 100 adjusts the symmetry of the S-shape of an FE signal by requiring upward driving the objective lens 32 to be performed only once before focusing is performed (before focus control is started).

The functions of the optical disc device 100 will now be described.

An illumination unit is formed by, for example, the laser light source 30.

A converging unit is formed by, for example, the objective lens 32.

A focus drive unit is formed by, for example, the focus actuator 33.

A light receiving unit is formed by, for example, the light receiving unit 34.

A measurement unit is formed by, for example, the prior-to-differentiation FE measurement unit 50.

A signal correction unit is formed by, for example, the balance circuit 40.

A focus error signal generation unit is formed by, for example, the differential circuit 41.

A signal ratio calculation unit is formed by, for example, the symmetry calculation unit 51.

A focus control unit is formed by, for example, the focus filter unit 54.

A focusing unit is formed by, for example, the focusing unit 55 and the focus drive output switch 53.

A spherical aberration correction unit is formed by, for example, the spherical aberration control unit 52 and the spherical aberration correction unit 35.

The optical head 20 of the optical disc device 100 has the same structure as the optical head 10 of the conventional optical disc device 900 except that it additionally includes the spherical aberration correction unit 35.

The spherical aberration correction unit 35 corrects the spherical aberration of a light beam emitted from the laser light source 30.

The controller 56 transmits a correction command for correcting the spherical aberration of the light beam to the spherical aberration control unit 52.

The spherical aberration control unit 52 receives a correction command from the controller 56, and transmits a drive signal for correcting the spherical aberration of the light beam to the spherical aberration correction unit 35.

The controller 56 further transmits a command for causing the spot of the light beam that has converged after passing through the objective lens 32 to follow the track in a direction perpendicular to an information surface of the optical disc 1 (in the direction of the normal to an information surface of the optical disc 1), or in other words a command for searching the information surface, to the focusing unit 55.

The focusing unit 55 receives an output from the controller 56 and an output from the subtraction unit (differential circuit) 41. The focusing unit 55 receives a command from the controller 56, and switches the switch unit (focus drive output switch) 53. More specifically, when receiving a command for searching the in formation surface from the controller 56 (this state may be referred to as an “information surface searching mode”), the focusing unit 55 switches the input of the switch unit (focus drive output switch) 53 in a manner that a signal output from the focusing unit 55 is output to the focus actuator 33. When receiving a command for executing focus control from the controller 56 (this state may be referred to as a “focus control mode”), the focusing unit 55 switches (selects) the input of the switch unit (focus drive output switch) 53 in a manner that a signal output from the focus filter unit 54 is output to the focus actuator 33.

In the information surface searching mode, the switch unit (focus drive output switch) 53 selectively outputs an output (a focus drive signal) from the focusing unit 55 to the focus actuator 33. More specifically, in the information surface searching mode, the switch unit 53 transmits, to the focus actuator 33, a focus drive signal (an output from the focusing unit 55) for moving the spot of the light beam that has converged after passing through the objective lens 32 upward and downward with respect to the optical disc 1. In response to the focus drive signal, the focus actuator 33 for driving the objective lens 32 is driven.

As the objective lens 32 is driven by the focus actuator 33, the focus of the light beam that has converged after passing through the objective lens 32 passes through the surface and the information surface of the optical disc 1. The differential circuit 41 outputs an FE signal, which shows an S-shaped waveform in an area around which the focus of the light beam passes through the surface or the information surface of the optical disc 1.

The prior-to-differentiation FE measurement unit 50 measures the level of a positive FE signal and the level of a negative FE signal, which are output from the light receiving unit 34, at a point where the signal level of the S-shape of the FE signal output from the subtraction unit (differential circuit) 41 is at its local maximum or local minimum during upward driving of the objective lens 32 performed by the focusing unit 55 (during driving of the objective lens 32 to move toward the optical disc 1 (upward in FIG. 1)). The prior-to-differentiation FE measurement unit 50 then outputs the measurement result to the symmetry calculation unit 51.

The symmetry calculation unit 51 receives an output from the prior-to-differentiation FE measurement unit, and calculates a gain value to be used by the balance circuit 40 based on the signal level of the S-shape of the positive FE signal and the signal level of the S-shape of the negative FE signal measured by the prior-to-differentiation FE measurement unit 50 (the signal level of the positive FE signal and the signal level of the negative FE signal at a point where the signal level of the S-shape of the FE signal is at its local maximum or local minimum). The symmetry calculation unit 51 then sets the calculated gain value to be used by the balance circuit 40.

The focusing unit 55 switches the switch unit (focus drive output switch) 53 in a manner that a signal output from the focus filter unit 54 is input into the switch unit (focus drive output switch) 53 at a point where the S-shape of the FE signal crosses the zero level during downward driving of the objective lens 32 (during driving of the objective lens 32 to move away from the optical disc 1 (downward in FIG. 1)). As a result, the optical disc device 100 starts focus control on the information surface of the optical disc 1.

The focus filter unit 54 receives an FE signal output from the subtraction unit (differential circuit) 41, and generates a focus drive signal in a manner that the level of the FE signal will be substantially zero. The focus filter unit 54 outputs the generated focus drive signal to the switch unit (focus drive output switch) 53. The focus filter unit 54 is preferably formed by a phase compensating filter (proportional-integral-derivative (PID) filter).

In response to the focus drive signal output from the focus filter unit 54, the focus actuator 33 for driving the objective lens 32 is driven. As a result, the optical disc device 100 starts focus control.

### 1.2 Operation of the Optical Disc Device

The operation of the optical disc device 100 of the present embodiment will now be described in detail with reference to the waveform diagrams of FIGS. 2A to 2D.

FIG. 2A shows a signal indicating the position of the objective lens 32 during focusing operation performed by the focusing unit 55. In FIG. 2A, the horizontal axis indicates time and the vertical axis indicates the signal level.

FIG. 2B shows an FE signal during focusing operation performed by the focusing unit 55. In FIG. 2B, the horizontal axis indicates time and the vertical axis indicates the signal level.

FIG. 2C shows a positive FE signal during focusing operation performed by the focusing unit 55. In FIG. 2C, the horizontal axis indicates time and the vertical axis indicates the signal level.

FIG. 2D shows a negative FE signal during focusing operation performed by the focusing unit 55. In FIG. 2D, the horizontal axis indicates time and the vertical axis indicates the signal level.

### Spherical Aberration Correction

The controller 56 first corrects the spherical aberration of a light beam in a manner to reduce the spherical aberration on the information surface of the optical disc 1, which is to be controlled through focus control. More specifically, the spherical aberration control unit 52 outputs a drive signal for correcting the spherical aberration of the light beam to the spherical aberration correction unit 35 based on a correction command output from the controller 56. The spherical aberration correction unit 35 then corrects the spherical aberration of the light beam in a manner to reduce the spherical aberration on the information surface of the optical disc 1.

### T100:

At timing T100, the controller 56 controls the focusing unit 55 to start focusing operation. This starts upward driving of the objective lens 32. When the level of the FE signal exceeds a level L1 shown in FIG. 2B, the prior-to-differentiation FE measurement unit 50 starts detecting a local maximum point of the FE signal.

### T101:

At timing T101, the prior-to-differentiation FE measurement unit 50 measures a level L4 of the positive FE signal at the timing when the local maximum point of the FE signal is detected.

Subsequently, the prior-to-differentiation FE measurement unit 50 starts detecting a local minimum point of the FE signal when the level of the FE signal decreases below a level L2.

### T102:

At timing T102, the prior-to-differentiation FE measurement unit 50 measures a level L5 of the negative FE signal at the timing when the local minimum point of the FE signal is detected.

The symmetry calculation unit 51 then calculates the gain value of the balance circuit 40, by which the negative FE signal is to be multiplied, based on the ratio of the level L4 of the positive FE signal at the local maximum point of the FE signal and the level L5 of the negative FE signal at the local minimum point of the FE signal, which are obtained by the prior-to-differentiation FE measurement unit 50. The symmetry calculation unit 51 sets the calculated gain value G (for example, G=L4/L5) to be used by the balance circuit 40. In this example, the gain value G set to be used by the balance circuit 40 may be, for example,

G=L4/L5.

Alternatively, a gain adjustment unit that adjusts the gain of the positive FE signal may be arranged between the light receiving unit 34 and the subtraction unit 41 and a gain adjustment unit that adjusts the gain of the negative FE signal may be arranged between the balance circuit 40 and the subtraction unit 41, and the positive FE signal output from the light receiving unit 34 and the positive FE signal output from the balance circuit 40 may be multiplied by a predetermined gain K1. In this case, the positive FE signal and the negative FE signal input into the subtraction unit 41 are written as follows:

Positive FE signal input into the subtraction unit 41=(positive FE signal output from the light receiving unit 34)*K1, and

Negative FE signal input into the subtraction unit 41=(negative FE signal output from the light receiving unit 34)*(L4/L5)*K1.

In this case, the positive FE signal and the negative FE signal will have S-shaped waveforms having substantially the same signal level. The subtraction unit 41 performs subtraction using the positive FE signal and the negative FE signal to generate an FE signal. The resulting FE signal has a highly symmetric S-shape.

The processing described above is a mere example of gain adjustment of the positive FE signal and the negative FE signal, and the present invention should not be limited to this structure.

### T103:

At timing T103, the focusing unit 55 starts downward driving of the objective lens 32 based on a command from the controller 56.

When the level of the FE signal decreases below a level L3, the focusing unit 55 starts detecting the timing at which the level of the FE signal crosses the zero level.

### T104:

At timing T104, the focusing unit 55 detects a point where the S-shaped waveform of the FE signal crosses the zero level (a zero crossing point), and starts focus control. The point where the S-shaped waveform of the FE signal crosses the zero level is detected at timing TT shown in FIGS. 2A to 2D. In this case, focus control should ideally be started at timing TT. In the present embodiment, however, focus control is actually started at timing T104 shown in FIGS. 2A to 2D due to response delay of the actuator 33. An actuator with good response may be used, and focus control may be started at timing TT. To increase the reliability of the detected zero crossing point, a point where the signal level of the FE signal changes from a negative to a positive value may be determined as the zero crossing point. This determination reduces erroneous detection of the zero crossing point.

As described above, the optical disc device 100 optimizes, before focusing is performed, the spherical aberration of the light beam on the information surface of the optical disc 1 to be controlled through focus control, and calculates and sets the gain value to be used by the balance circuit 40 during upward driving of the objective lens 32 based on the positive FE signal and the negative FE signal obtained before differentiation. The optical disc device 100 with this structure adjusts the symmetry (symmetry of the S-shape) of an FE signal with a high precision by requiring the operation of driving the objective lens 32 upward to be performed only once.

Although the present embodiment describes the case in which the symmetry of an FE signal is adjusted using upward driving of the objective lens 32 during focusing operation, the present invention should not be limited to this structure. For example, the symmetry (symmetry of the S-shape) of an FE signal may be adjusted using the operation of driving the objective lens 32 either upward or downward or both upward and downward. For example, the symmetry of an FE signal may be adjusted using upward and downward driving of the objective lens 32 that is performed to determine the type of the optical disc 1 mounted on the optical disc device 100.

Although the present embodiment describes the case in which the symmetry of an FE signal is adjusted based on a positive FE signal and a negative FE signal obtained only during upward driving of the objective lens 32, the present invention should not be limited to this structure. For example, the symmetry (symmetry of the S-shape) of an FE signal may be adjusted only during downward driving of the objective lens 32 or during both upward and downward driving of the objective lens 32.

Alternatively, the optical disc device 100 may calculate an optimal gain value of the balance circuit 40 based on data indicating the symmetry of an FE signal obtained by calculating the average of a symmetry adjustment result of the FE signal during upward driving of the objective lens 32 and a symmetry adjustment result of the FE signal during downward driving of the objective lens 32, and may set the calculated optimal gain value to be used by the balance circuit 40.

Alternatively, the optical disc device 100 may obtain a symmetry adjustment result of the FE signal during upward driving of the objective lens 32 and a symmetry adjustment result of the FE signal during downward driving of the objective lens 32, and may select one of the symmetry adjustment results and calculate an optimal gain value of the balance circuit 40 based on the selected adjustment result of the symmetry (symmetry of the S-shape) of the FE signal, and may set the calculated optimal gain value to be used by the balance circuit 40. Although the present embodiment describes the case in which the positive FE signal and the negative FE signal are measured at the local maximum point and the local minimum point of the FE signal, the present invention should not be limited to this structure. For example, the gain value of the balance circuit 40 may be set (the symmetry of the S-shape of the FE signal may be adjusted) in the manners (1) to (3) below.

(1) The prior-to-differentiation FE measurement unit 50 detects a local maximum value of the FE signal, and measures a signal level maxP1 of the positive FE signal and a signal level maxM1 of the negative FE signal corresponding to the local maximum value of the FE signal, and stores the measured signal level maxP1 of the positive FE signal and the measured signal level maxM1 of the negative FE signal.

(2) The prior-to-differentiation FE measurement unit 50 detects a local minimum value of the FE signal, and measures a signal level minP2 of the positive FE signal and a signal level minM2 of the negative FE signal corresponding to the local minimum value of the FE signal, and stores the measured signal level minP2 of the positive FE signal and the measured signal level minM2 of the negative FE signal.

(3) The prior-to-differentiation FE measurement unit 50 calculates an optimal gain value of the balance circuit 40 based on the four signal levels maxP1, maxM1, minP2, and minM2 obtained in the manners (1) and (2), and sets the calculated optimal gain value to be used by the balance circuit 40.

Although the present embodiment describes the case in which the device determines the level of the FE signal first using the level L1 and then using the level L2, the present invention should not be limited to this structure. For example, the device may determine the level of the FE signal first using the level L2 and then using the level L1. In this manner, the present invention may be applied to an FE signal having the polarity inverse to the polarity of the FE signal described in the present embodiment.

Alternatively, the optical disc device 100 may not determine the level of the FE signal using the levels L1 and L2, but may adjust the symmetry of the FE signal by detecting a local maximum point and a local minimum point of the FE signal.

The signal polarities of the positive FE signal and the negative FE signal may be inverse to the polarities described in the present embodiment.

The phase relationship between the positive FE signal and the negative FE signal may be inverse to the phase relationship described in the present embodiment.

Although the present embodiment describes the case in which the device adjusts the level of the positive FE signal at the local maximum point of the FE signal and the level of the negative FE signal at the local minimum point of the FE signal to be substantially the same level, the present invention should not be limited to this structure. For example, the device may adjust the symmetry (symmetry of the S-shape) of the FE signal by adjusting the level of the positive FE signal and the level of the negative FE signal in a manner that a difference between the level of the positive FE signal and the level of the negative FE signal at the local maximum point of the FE signal will be substantially the same as a difference between the level of the positive FE signal and the level of the negative FE signal at the local minimum point of the FE signal.

Although the present embodiment describes the case in which the balance circuit 40 that performs signal correction is arranged at the negative FE signal side, the present invention should not be limited to this structure. For example, the balance circuit 40 may be arranged at the positive FE signal side.

Alternatively, the balance circuit 40 may be arranged at each of the positive FE signal side and the negative FE signal side. In this case, the symmetry calculation unit 51 adjusts the symmetry (symmetry of the S-shape) of an FE signal by setting the gain of a balance circuit arranged at the positive FE signal side and the gain of a balance circuit arranged at the negative FE signal side.

The optical disc 1 may have a plurality of information surfaces.

### Second Embodiment

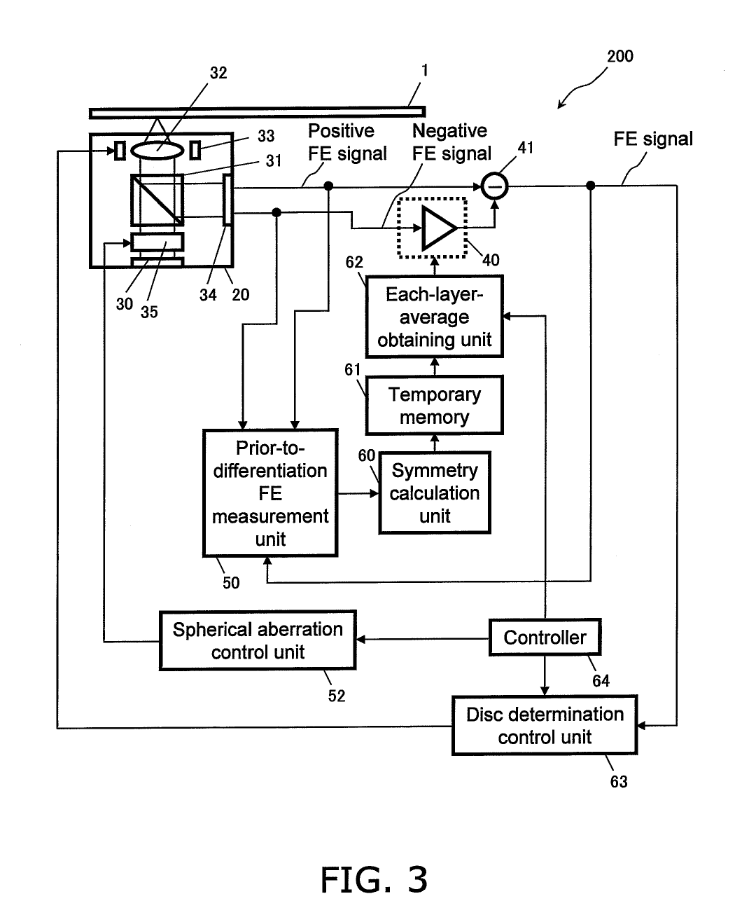

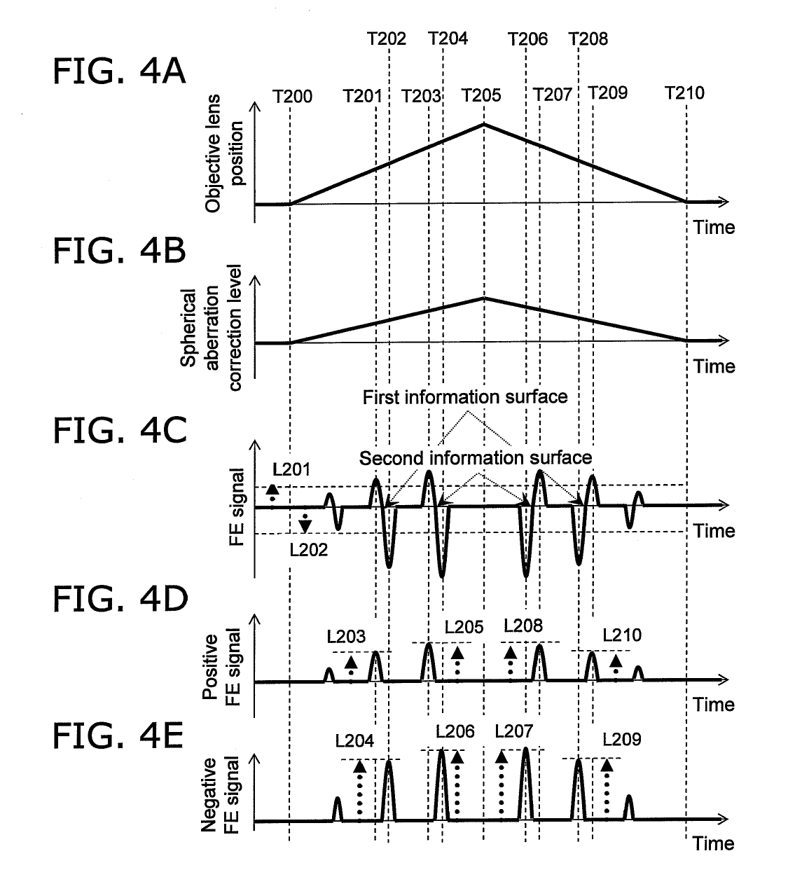

A second embodiment of the present invention will now be described with reference to FIGS. 3 and 4A to 4E.

### 2.1 Structure of the Optical Disc Device

FIG. 3 is a block diagram schematically showing the structure of an optical disc device 200 according to the present embodiment.

As shown in FIG. 3, the optical disc device 200, which records and reads information on an optical disc 1, includes an optical head 20, a balance adjustment unit (balance circuit) 40, a subtraction unit (differential circuit) 41, a prior-to-differentiation FE measurement unit 50, a symmetry calculation unit 60, a temporary memory 61, and an each-layer-average obtaining unit 62. The optical disc device 200 further includes a controller 64, a spherical aberration control unit 52, and a disc determination control unit 63.

The components of the optical disc device 200 that are the same as the components of the device according to the first embodiment will be given the same reference numerals as those components, and will not be described in detail.

The optical disc device 200 of the second embodiment differs from the device of the conventional example and the device of the first embodiment in that the device 200 uses the symmetry calculation unit 60, the temporary memory 61, the each-layer-average obtaining unit 62, the disc determination control unit 63, and the controller 64, and the device 200 adjusts the symmetry of the S-shape of an FE signal on all information surfaces of the optical disc 1 with a high precision by requiring upward and downward driving of the objective lens 32 to be performed only once during disc determination. The functions of the optical disc device 200 will now be described.

An illumination unit is formed by, for example, the laser light source 30.

A converging unit is formed by, for example, the objective lens 32.

A focus drive unit is formed by, for example, the focus actuator 33.

A light receiving unit is formed by, for example, the light receiving unit 34.

A measurement unit is formed by, for example, the prior-to-differentiation FE measurement unit 50.

A signal correction unit is formed by, for example, the balance circuit 40.

A focus error signal generation unit is formed by, for example, the differential circuit 41.

A signal ratio calculation unit is formed by, for example, the symmetry calculation unit 60.

A disc determination unit is formed by, for example, the disc determination control unit 63.

A signal ratio optimization unit is formed by, for example, the temporary memory 61 and the each-layer-average obtaining unit 62.

A spherical aberration correction unit is formed by, for example, the spherical aberration control unit 52 and the spherical aberration correction unit 35.

The controller 64 transmits a disc determination command for starting the operation of determining the type of the optical disc 1 mounted on the optical disc device 200 to the disc determination control unit 63.

The disc determination control unit 63 receives a disc determination command from the controller 64, and transmits, to the focus actuator 33, a drive signal for driving the spot of the light beam that has converged after passing through the objective lens 32 to move upward and downward with respect to the optical disc 1. As the objective lens 32 is driven by the focus actuator 33, the focus of the light beam that has converged after passing through the objective lens 32 passes through the surface and the information surfaces of the optical disc 1. The differential circuit 41 outputs an FE signal, which shows an S-shaped waveform in an area around which the focus of the light beam passes through the surface or the information surfaces of the optical disc 1.

The prior-to-differentiation FE measurement unit 50 measures the level of a positive FE signal and the level of a negative FE signal output from the light receiving unit 34 at a point where the signal level of the S-shaped waveform of an FE signal output from the subtraction unit (differential circuit) 41 is at its local maximum or local minimum during upward and downward driving of the objective lens 32 performed by the disc determination control unit 63. The prior-to-differentiation FE measurement unit 50 outputs the measured value to the symmetry calculation unit 60.

The symmetry calculation unit 60 calculates an optimal gain value of the balance circuit 40 based on the signal level of the S-shape of the positive FE signal and the signal level of the S-shape of the negative FE signal measured by the prior-to-differentiation FE measurement unit 50 (the signal level of the positive FE signal and the signal level of the negative FE signal at the point where the signal level of the S-shape of the FE signal is at its local maximum or local minimum), and outputs the calculated optimal gain value to the temporary memory 61.

The temporary memory 61 stores the gain value output from the symmetry calculation unit 60.

The optical disc device 200 repeatedly performs the above operation (processing) of (1) measurement by the prior-to-differentiation FE measurement unit 50, (2) calculation by the symmetry calculation unit 60, and (3) storing the calculation result by the temporary memory 61, on the S-shape (S-shaped waveform) of an FE signal corresponding to each of all the information surfaces of the optical disc 1, which is detected during upward and downward driving of the objective lens 32 performed by the disc determination control unit 63. The optical disc device 200 stores a plurality of gain values of the balance circuit 40 for the plurality of information surfaces, which are calculated by the symmetry calculation unit 60, into different memory areas (the gain values are stored as separate data sets in the temporary memory 61). As a result, two gain values, or specifically a gain value obtained during upward driving of the objective lens 32 and a gain value obtained during downward driving of the objective lens 32, per information surface of the optical disc 1 are stored into the temporary memory 61.

The controller 64 transmits, to the spherical aberration control unit 52, a spherical aberration correction command for correcting the spherical aberration of the light beam in a manner to reduce the spherical aberration at a constant correction speed on each information surface in parallel with upward and downward driving of the objective lens 32 when the focus of the light beam passes through each information surface of the optical disc 1.

The spherical aberration control unit 52 receives a spherical aberration correction command from the controller 64, and transmits a drive signal for correcting the spherical aberration of the light beam to the spherical aberration correction unit 35.

When the upward and downward driving of the objective lens 32 performed by the disc determination control unit 63 is completed, the controller 64 transmits an average obtaining command to the each-layer-average obtaining unit 62.

The each-layer-average obtaining unit 62 receives an average obtaining command from the controller 64, and fetches all data stored in the temporary memory 61, and calculates, for each of all the information surfaces, the average of a gain value obtained during upward driving of the objective lens 32 and a gain value obtained during downward driving of the objective lens 32. The each-layer-average obtaining unit 62 then sets each calculated average gain value to be used by the balance circuit 40.

### 2.2 Operation of the Optical Disc Device

The operation of the optical disc device 200 of the present embodiment will now be described in detail with reference to the waveform diagrams of FIGS. 4A to 4E.

FIG. 4A shows a signal indicating the position of the objective lens 32 during disc determination performed by the disc determination control unit 63. In FIG. 4A, the horizontal axis indicates time and the vertical axis indicates the signal level.

FIG. 4B shows a signal indicating a correction level of the spherical aberration correction unit 35 during disc determination performed by the disc determination control unit 63. In FIG. 4B, the horizontal axis indicates time and the vertical axis indicates the signal level.

FIG. 4C shows an FE signal during disc determination performed by the disc determination control unit 63. In FIG. 4C, the horizontal axis indicates time and the vertical axis indicates the signal level.

FIG. 4D shows a positive FE signal during disc determination performed by the disc determination control unit 63. In FIG. 4D, the horizontal axis indicates time and the vertical axis indicates the signal level.

FIG. 4E shows a negative FE signal during disc determination performed by the disc determination control unit 63. In FIG. 4E, the horizontal axis indicates time and the vertical axis indicates the signal level.

### T200:

At timing T200, the controller 64 controls the disc determination control unit 63 to start disc determination. This starts upward driving of the objective lens 32.

When the level of the FE signal increases above a level L201 shown in FIG. 4C, the prior-to-differentiation FE measurement unit 50 starts detecting a local maximum point of the FE signal.

### T201:

At timing T201, the prior-to-differentiation FE measurement unit 50 measures a level L203 of the positive FE signal at the timing when the local maximum point of the FE signal is detected.

Subsequently, the prior-to-differentiation FE measurement unit 50 starts detecting a local minimum point of the FE signal when the level of the FE signal decreases below a level L202.

### T202:

At timing T202, the prior-to-differentiation FE measurement unit 50 measures a level L204 of the negative FE signal at the timing when the local minimum point of the FE signal is detected.

The symmetry calculation unit 51 then calculates the gain value of the balance circuit 40, by which the negative FE signal is to be multiplied, based on the ratio of the level L203 of the positive FE signal at the local maximum point of the FE signal and the level L204 of the negative FE signal at the local minimum point of the FE signal, which are obtained by the prior-to-differentiation FE measurement unit 50. The symmetry calculation unit 51 stores the calculated gain value into the temporary memory 61 as a gain value corresponding to a first information surface.

### T203, T204:

The prior-to-differentiation FE measurement unit 50 starts detecting a local maximum point and a local minimum point of the FE signal based on comparison between the level of the FE signal and the level L201 and comparison between the level of the FE signal and the level L202, and obtains measurement results of the positive FE signal at the local maximum point and the local minimum point of the FE signal or measurement results of the negative FE signal at the local maximum point and the local minimum point of the FE signal. The symmetry calculation unit 60 then calculates the gain value of the balance circuit 40 based on the measurement results obtained by the prior-to-differentiation FE measurement unit 50. The optical disc device 200 repeats this operation (processing) until upward and downward driving of the objective lens 32 is completed.

The optical disc device 200 with this structure further measures a level L205 of the positive FE signal and a level L206 of the negative FE signal at timings T203 and T204 during upward driving of the objective lens 32, and calculates a gain value corresponding to a second information surface based on the ratio of the level L205 of the positive FE signal and the level L206 of the negative FE signal.

### T205 to T207:

At timing T205, the disc determination control unit 63 stops upward driving of the objective lens 32 based on a command from the controller 64 and starts downward driving of the objective lens 32.

During downward driving of the objective lens 32, the optical disc device 200 measures a level L207 of the negative FE signal and a level L208 of the positive FE signal at timings T206 and T207, and calculates a gain value corresponding to the second information surface based on the ratio of the level L207 of the negative FE signal and the level L208 of the positive FE signal.

### T208, T209:

At timings T208 and T209, the optical disc device 200 measures a level L209 of the negative FE signal and a level L210 of the positive FE signal, and calculates a gain value corresponding to the first information surface based on the ratio of the level L209 of the negative FE signal and the level L210 of the positive FE signal.

### Spherical Aberration Correction

The controller 64 corrects, using the spherical aberration control unit 52 and the spherical aberration correction unit 35, the spherical aberration of the light beam in parallel with upward and downward driving of the objective lens 32 in a manner to

(1) reduce the spherical aberration on the first information surface when the focus of the light beam passes through the first information surface, and

(2) reduce the spherical aberration on the second information surface when the focus of the light beam passes through the second information surface.

### T210:

At timing T210, the downward driving of the objective lens 32 is completed.

In this state, the temporary memory 61 stores two gain values corresponding to the first information surface, which are specifically a gain value obtained during upward driving and a gain value obtained during downward driving of the objective lens 32. Also, the temporary memory 61 stores two gain values corresponding to the second information surface, which are specifically a gain value obtained during upward driving and a gain value obtained during downward driving of the objective lens 32.

In accordance with a command from the controller 64, The each-layer-average obtaining unit 62 obtains, as a gain value corresponding to the first information surface, the average of the gain value obtained during upward driving of the objective lens 32 and the gain value obtained during downward driving of the objective lens 32 based on the gain value data stored in the temporary memory 61, and also obtains as a gain value corresponding to the second information surface, the average of the gain value obtained during upward driving of the objective lens 32 and the gain value obtained during downward driving of the objective lens 32 based on the gain value data stored in the temporary memory 61. The each-layer-average obtaining unit 62 then sets each calculated average value as the gain value to be used by the balance circuit 40.

As described above, the optical disc device 200 calculates the gain value of the balance circuit 40 based on a positive FE signal and a negative FE signal obtained before differentiation during upward and downward driving of the objective lens 32 performed for disc determination, while (in parallel with) correcting the spherical aberration of the light beam in a manner to reduce the spherical aberration on each of all the information surfaces. The optical disc device 200 then obtains, as the gain value corresponding to each information surface, the average of a gain value obtained during upward driving of the objective lens 32 and a gain value obtained during downward driving of the objective lens 32. As a result, the optical disc device 200 adjusts the gain value of the balance circuit 40 corresponding to each information surface of the optical disc 1 with a high precision by requiring upward and downward driving of the objective lens 32 to be performed only once.

The optical disc device 200 with this structure adjusts the symmetry (symmetry of the S-shape) of an FE signal with a high precision by requiring the operation of driving the objective lens 32 upward and downward to be performed only once.

Although the optical disc device 200 of the present embodiment adjusts the symmetry of an FE signal using upward and downward driving of the objective lens 32 performed during disc determination, the present invention should not be limited to this structure. For example, the optical disc device 200 may alternatively adjust the symmetry (symmetry of the S-shape) of an FE signal using the operation of driving the objective lens 32 either upward or downward or both upward and downward.

Although the present embodiment describes the case in which the symmetry of an FE signal is adjusted during both upward and downward driving of the objective lens 32, the present invention should not be limited to this structure. For example, the symmetry of an FE signal may be adjusted only during upward driving of the objective lens 32 or only during downward driving of the objective lens 32.

Although the present embodiment describes the case in which the average of a gain value obtained during upward driving of the objective lens and a gain value obtained during downward driving of the objective lens 32 is used as an optimal gain value, the present invention should not be limited to this structure. For example, a gain value obtained during upward driving of the objective lens 32 may be used as an optimal gain value, or a gain value obtained during downward driving of the objective lens 32 may be used as an optimal gain value.

Alternatively, the optical disc device 200 may select one of a symmetry adjustment result of the FE signal obtained during upward driving of the objective lens 32 and a symmetry adjustment result of the FE signal obtained during downward driving of the objective lens 32 and calculate an optimal gain value based on the selected symmetry adjustment result, and may set the calculated optimal gain value to be used by the balance circuit 40.

Although the present embodiment describes the case in which a positive FE signal and a negative FE signal are measured at the local maximum point and the local minimum point of an FE signal, the present invention should not be limited to this structure. For example, the gain value of the balance circuit 40 may be set (the symmetry of the S-shape of the FE signal may be adjusted) in the manners (1) to (3) below.

(1) The prior-to-differentiation FE measurement unit 50 detects a local maximum value of an FE signal, and measures a signal level maxP1 of a positive FE signal and a signal level maxM1 of a negative FE signal at the local maximum value of the FE signal, and stores the measured signal level maxP1 of the positive FE signal and the measured signal level maxM1 of the negative FE signal.

(2) The prior-to-differentiation FE measurement unit 50 detects a local minimum value of an FE signal, and measures a signal level minP2 of a positive FE signal and a signal level minM2 of a negative FE signal at the local minimum value of the FE signal, and stores the measured signal level minP2 of the positive FE signal and the measured signal level minM2 of the negative FE signal.

(3) The prior-to-differentiation FE measurement unit 50 calculates an optimal gain value of the balance circuit 40 based on the signal levels maxP1, maxM1, minP2, and minM2 obtained in the manners (1) and (2), and sets the calculated optimal gain value to be used by the balance circuit 40.

The signal polarities of the positive FE signal and the negative FE signal may be inverse to the polarities described in the present embodiment.

The optical disc device 200 may not determine the level of the FE signal using the level L201 and the level L202, but may detect a local maximum point and a local minimum point of the signal level of the FE signal.

The signal polarities of the positive FE signal and the negative FE signal may be inverse to the signal polarities described in the present embodiment.

The phase relationship between the positive FE signal and the negative FE signal may be inverse to the phase relationship described in the present embodiment.

Although the present embodiment describes the case in which the device adjusts the level of the positive FE signal at the local maximum point of the FE signal and the level of the negative FE signal at the local minimum point of the FE signal to be substantially the same level, the present invention should not be limited to this structure. For example, the device may adjust the symmetry (symmetry of the S-shape) of the FE signal by adjusting the level of the positive FE signal and the level of the negative FE signal in a manner that a difference between the level of the positive FE signal and the level of the negative FE signal at the local maximum point of the FE signal will be substantially the same as a difference between the level of the positive FE signal and the level of the negative FE signal at the local minimum point of the FE signal.

Although the present embodiment describes the case in which the balance circuit 40 that performs signal correction is arranged at the negative FE signal side, the present invention should not be limited to this structure. For example, the balance circuit 40 may be arranged at the positive FE signal side.

Alternatively, the balance circuit 40 may be arranged at each of the positive FE signal side and the negative FE signal side. In this case, the symmetry calculation unit 51 adjusts the symmetry (symmetry of the S-shape) of an FE signal by setting the gain of a balance circuit arranged at the positive FE signal side and the gain of a balance circuit arranged at the negative FE signal side.

Although the present embodiment describes the case in which the spherical aberration correction and the upward and downward driving of the objective lens 32 are performed in parallel, the present invention should not be limited to this structure. For example, the independent operation of first correcting the spherical aberration and then driving the objective lens 32 upward and downward may be performed for each of all the information surfaces of the optical disc 1.

Although the present embodiment describes the case in which the spherical aberration of the light beam is corrected on each information surface of the optical disc 1, the present invention should not be limited to this structure. For example, the spherical aberration may not be corrected on each information surface but may be corrected using an intermediate value of the spherical aberration values on a plurality of information surfaces.

Although the present embodiment describes the case in which the average of gain values corresponding to each information surface is calculated after upward and downward driving of the objective lens 32 is completed, the present invention should not be limited to this structure. For example, the average of gain values corresponding to each information surface may be calculated when a gain value during upward driving and a gain value during downward driving are obtained for a selected information surface.

Although the present embodiment describes the case in which the calculated gain value is stored into memory, the present invention should not be limited to this structure. For example, the level of a positive FE signal and the level of a negative FE signal obtained before the gain value to be used by the balance circuit 40 is calculated (the level of a positive FE signal and the level of a negative FE signal used to calculate the gain value) may be stored into memory, and gain calculation may be performed (gain values may be calculated) and the average of the gain values may be obtained based on the level of the positive FE signal and the level of the negative FE signal stored in the memory.

The optical disc 1 may have two or more information surfaces.

Although the present embodiment describes the case in which the objective lens 32 is driven upward and downward while the spherical aberration is being corrected at a constant speed, the present invention should not be limited to this structure. For example, the correction speed may not be constant. It is only required, for example, that the light beam should show a corrected spherical aberration on each information surface when the spot of the light beam passes through each information surface.

Although the present embodiment describes the case in which a different gain value is calculated for each of all the information surfaces of the optical disc 1, the present invention should not be limited to this structure. For example, one or more gain values that are commonly used for a plurality of information surfaces may be further calculated based on the gain value calculated for each of all the information surfaces. When, for example, the optical disc 1 has two information surfaces L0 and L1 and a gain value GL0 is calculated for the information surface L0 and a gain value GL1 is calculated for the information surface L1, a gain value (GL0+GL1)/2 may be further obtained as a gain value commonly used for the two information surfaces.

### Third Embodiment

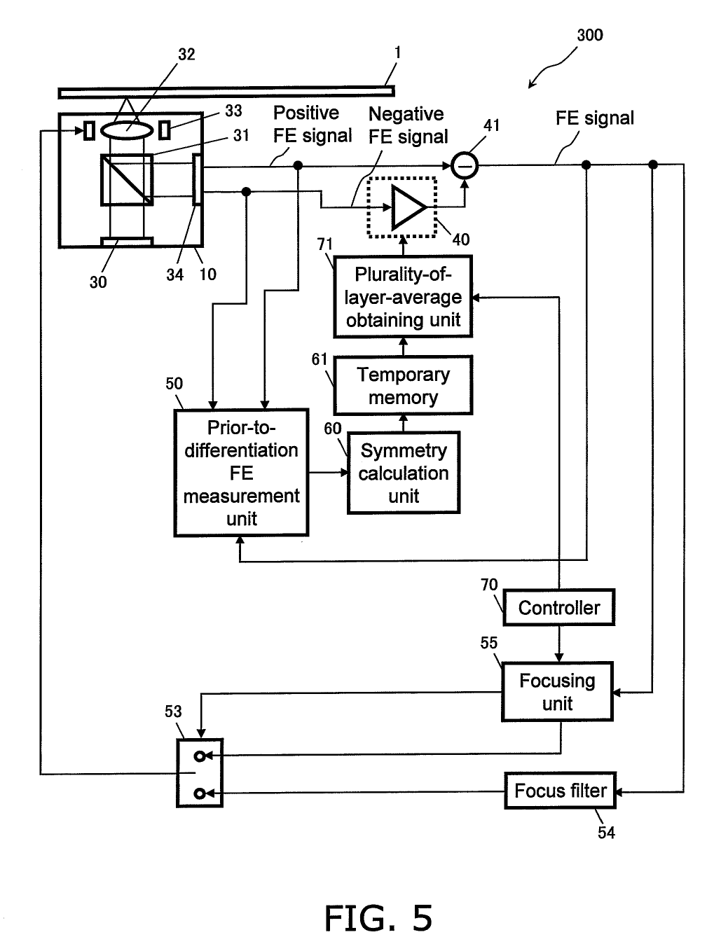

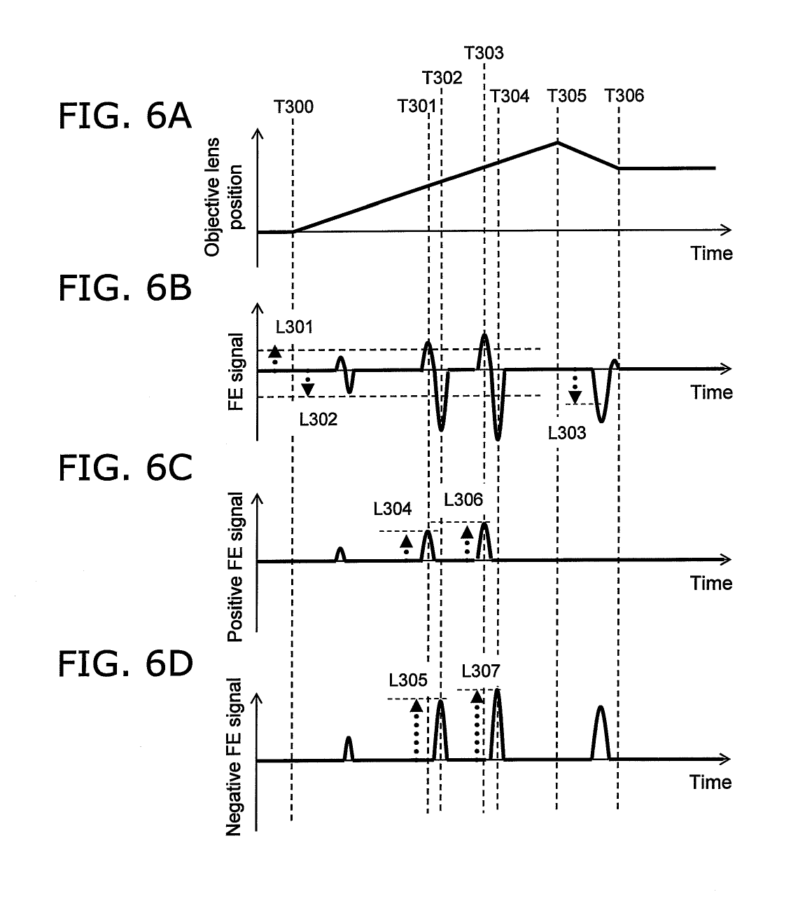

A third embodiment of the present invention will now be described with reference to FIGS. 5 and 6A to 6D.

### 3.1 Structure of the Optical Disc Device

FIG. 5 is a block diagram schematically showing the structure of an optical disc device 300 according to the present embodiment.

As shown in FIG. 5, the optical disc device 300, which records and reads information on an optical disc 1, includes an optical head 10, a balance adjustment unit (balance circuit) 40, a subtraction unit (differential circuit) 41, a prior-to-differentiation FE measurement unit 50, a symmetry calculation unit 60, a temporary memory 61, and a plurality-of-layer-average obtaining unit 71. The optical disc device 300 further includes a controller 70, a focusing unit 55, a focus filter unit 54, and a switch unit (focus drive output switch) 53.

The optical head 10 includes a laser light source 30, a beam splitter 31, an objective lens 32, a focus actuator 33, and a light receiving unit 34.

The components of the optical disc device 300 that are the same as the components of the devices according to the above embodiments will be given the same reference numerals as those components, and will not be described in detail.

The optical disc device 300 of the third embodiment differs from the device of the conventional example and the devices of the above embodiments in that the device 300 uses the controller 70 and the plurality-of-layer-average obtaining unit 71, and the device 300 calculates a single optimal gain value for a plurality of information surfaces of the optical disc 1 and adjusts the symmetry of the S-shape of an FE signal based on the calculated gain value by requiring upward driving of the objective lens 32 to be performed only once before focusing is performed. The functions of the optical disc device 300 will now be described.

An illumination unit is formed by, for example, the laser light source 30.

A converging unit is formed by, for example, the objective lens 32.

A focus drive unit is formed by, for example, the focus actuator 33.

A light receiving unit is formed by, for example, the light receiving unit 34.

A measurement unit is formed by, for example, the prior-to-differentiation FE measurement unit 50.

A signal correction unit is formed by, for example, the balance circuit 40.

A focus error signal generation unit is formed by, for example, the differential circuit 41.

A signal ratio calculation unit is formed by, for example, the symmetry calculation unit 60.

A focus control unit is formed by, for example, the focus filter unit 54.

A focusing unit is formed by, for example, the focusing unit 55 and the focus drive output switch 53.

A plurality-of-information-surface signal ratio calculation unit is formed by, for example, the temporary memory 61 and the plurality-of-layer-average obtaining unit 62.

The controller 70 transmits a command for causing the spot of a light beam that has converged after passing through the objective lens 32 to follow the track in a direction perpendicular to an information surface of the optical disc 1 (command for searching an information surface) to the focusing unit 55.

The focusing unit 55 receives an output from the controller 70 and an output from the subtraction unit (differential circuit) 41. The focusing unit 55 receives a command from the controller 70, and switches the switch unit (focus drive output switch) 53. More specifically, when receiving a command for searching an information surface from the controller 70 (when in an “information surface searching mode”), the focusing unit 55 switches the input of the switch unit (focus drive output switch) 53 in a manner that a signal output from the focusing unit 55 is output to the focus actuator 33. When receiving a command for executing focus control from the controller 70 (when in a “focus control mode”), the focusing unit 55 switches (selects) the input of the switch unit (focus drive output switch) 53 in a manner that a signal output from the focus filter unit 54 is output to the focus actuator 33.

In the information surface searching mode, the switch unit (focus drive output switch) 53 selectively outputs an output (a focus drive signal) from the focusing unit 55 to the focus actuator 33. More specifically, in the information surface searching mode, the switch unit 53 transmits a focus drive signal (output from the focusing unit 55), which causes the spot of the light beam that has converged after passing through the objective lens 32 to move upward and downward with respect to the optical disc 1, to the focus actuator 33.

In response to the focus drive signal, the focus actuator 33 for driving the objective lens 32 is driven.

The prior-to-differentiation FE measurement unit 50 measures the level of a positive FE signal and the level of a negative FE signal, which are output from the light receiving unit 34, at a point where the signal level of the S-shape of the FE signal output from the subtraction unit (differential circuit) 41 is at its local maximum or local minimum during upward driving of the objective lens 32 performed by the focusing unit 55. The prior-to-differentiation FE measurement unit 50 then outputs the measurement result to the symmetry calculation unit 60.

The symmetry calculation unit 60 receives an output from the prior-to-differentiation FE measurement unit, and calculates an optimal gain value of the balance circuit 40 based on the signal level of the S-shape of the positive FE signal and the signal level of the S-shape of the negative FE signal measured by the prior-to-differentiation FE measurement unit 50, and outputs the calculated gain value to the temporary memory 61.

The temporary memory 61 stores the gain value output from the symmetry calculation unit 60.

The optical disc device 300 repeatedly performs the above operation (processing) of (1) measurement by the prior-to-differentiation FE measurement unit 50, (2) calculation by the symmetry calculation unit 60, and (3) storing the calculation result by the temporary memory 61, on the S-shape (S-shaped waveform) of an FE signal corresponding to each of all the information surfaces of the optical disc 1, which is detected during upward driving of the objective lens 32 performed by the focusing unit 55.

When the upward driving of the objective lens 32 performed by the focusing unit 55 is completed, the controller 70 transmits an average obtaining command to the plurality-of-layer-average obtaining unit 71.

The plurality-of-layer-average obtaining unit 71 receives an average obtaining command from the controller 70, and fetches all data stored in the temporary memory 61, and calculates the average of gain values corresponding to all the information surfaces obtained during upward driving of the objective lens 32. The plurality-of-layer-average obtaining unit 71 then sets the calculated average gain value to be used by the balance circuit 40.

### 3.2 Operation of the Optical Disc Device

The operation of the optical disc device 300 of the present embodiment will now be described in detail with reference to the waveform diagrams of FIGS. 6A to 6D.

FIG. 6A shows a signal indicating the position of the objective lens 32 during focusing operation performed by the focusing unit 55. In FIG. 6A, the horizontal axis indicates time and the vertical axis indicates the signal level.

FIG. 6B shows an FE signal during focusing operation performed by the focusing unit 55. In FIG. 6B, the horizontal axis indicates time and the vertical axis indicates the signal level.

FIG. 6C shows a positive FE signal during focusing operation performed by the focusing unit 55. In FIG. 6C, the horizontal axis indicates time and the vertical axis indicates the signal level.

FIG. 6D shows a negative FE signal during focusing operation performed by the focusing unit 55. In FIG. 6D, the horizontal axis indicates time and the vertical axis indicates the signal level.

### T300:

At timing T300, the controller 70 controls the focusing unit 55 to start focusing operation. This starts upward driving of the objective lens 32.

When the level of the FE signal increases above a level L301 shown in FIG. 6, the prior-to-differentiation FE measurement unit 50 starts detecting a local maximum point of the FE signal.

### T301:

At timing T301, the prior-to-differentiation FE measurement unit 50 measures a level L304 of the positive FE signal at the timing when the local maximum point of the FE signal is detected.

Subsequently, the prior-to-differentiation FE measurement unit 50 starts detecting a local minimum point of the FE signal when the level of the FE signal decreases below a level L302.

### T302:

At timing T302, the prior-to-differentiation FE measurement unit 50 measures a level L305 of the negative FE signal at the timing when the local minimum point of the FE signal is detected.

Subsequently, the symmetry calculation unit 51 calculates the gain value of the balance circuit 40, by which the negative FE signal is to be multiplied, based on the ratio of the level L304 of the positive FE signal at the local maximum point of the FE signal and the level L305 of the negative FE signal at the local minimum point of the FE signal, which are obtained by the prior-to-differentiation FE measurement unit 50. The gain value calculated by the symmetry calculation unit 51 is stored into the temporary memory 61.

### T303, T304:

The prior-to-differentiation FE measurement unit 50 starts detecting a local maximum point and a local minimum point of the FE signal based on comparison between the level of the FE signal and the level L301 and comparison between the level of the FE signal and the level L302, and obtains measurement results of the positive FE signal at the local maximum point and the local minimum point of the FE signal or measurement results of the negative FE signal at the local maximum point and the local minimum point of the FE signal. The symmetry calculation unit 60 then calculates the gain value of the balance circuit 40 based on the measurement results obtained by the prior-to-differentiation FE measurement unit 50. The optical disc device 300 repeats this operation (processing) until upward driving of the objective lens 32 is completed.

The optical disc device 300 with this structure further measures a level L306 of the positive FE signal and a level L307 of the negative FE signal at timings T303 and T304 during upward driving of the objective lens 32, and calculates a gain value based on the ratio of the level L306 of the positive FE signal and the level L307 of the negative FE signal.

### T305:

At timing T305, the upward driving of the objective lens 32 is completed.

In this state, the temporary memory 61 stores a plurality of gain values obtained during upward driving of the objective lens 32.

In accordance with a command from the controller 70, the plurality-of-layer-average obtaining unit 71 calculates the average of the plurality of gain values stored in the temporary memory 61, and sets the calculated average gain value to be used by the balance circuit 40.

At timing T305, the focusing unit 55 starts downward driving of the objective lens 32.

When the level of the FE signal decreases below a level L303, the focusing unit 55 starts detecting the timing at which the level of the FE signal crosses the zero level.

### T306:

At timing T306, the focusing unit 55 detects a point where the S-shape of the FE signal crosses the zero level, and starts focus control.

As described above, the optical disc device 300 calculates the gain value of the balance circuit 40 based on the positive FE signal and the negative FE signal obtained before differentiation during upward driving of the objective lens 32, and obtains the average of a plurality of gain values corresponding to a plurality of information surfaces, and sets the obtained average gain value to be used by the balance circuit 40.

The optical disc device 300 with this structure adjusts the symmetry (symmetry of the S-shape) of the FE signal using a common gain value over a plurality of layers by requiring upward driving of the objective lens 32 to be performed only once.

Although the present embodiment describes the case in which the symmetry of an FE signal is adjusted using upward driving of the objective lens 32 during focusing operation, the present invention should not be limited to this structure. For example, the symmetry of an FE signal may be adjusted using the operation of driving the objective lens 32 either upward or downward or both upward and downward. For example, the symmetry of an FE signal may be adjusted using upward and downward driving the objective lens 32 that is performed to determine the type of the optical disc 1 mounted on the optical disc device 300.

Although the present embodiment describes the case in which the symmetry of an FE signal is adjusted based on a positive FE signal and a negative FE signal obtained only during upward driving of the objective lens 32, the present invention should not be limited to this structure. For example, the symmetry of an FE signal may be adjusted only during downward driving of the objective lens 32 or during both upward and downward driving of the objective lens 32.

The optical disc device 300 may calculate the average of a symmetry adjustment result of the FE signal obtained during upward driving of the objective lens 32 and a symmetry adjustment result of the FE signal obtained during downward driving of the objective lens 32, and may use the calculated average gain value as an optimal gain value of the balance circuit 40.

Alternatively, the optical disc device 300 may obtain a symmetry adjustment result of the FE signal during upward driving of the objective lens 32 and a symmetry adjustment result of the FE signal during downward driving of the objective lens 32 and may select one of the symmetry adjustment results and calculate an optimal gain value of the balance circuit 40 based on the selected symmetry adjustment result of the FE signal, and may set the calculated optimal gain value to be used by the balance circuit 40.

Although the present embodiment describes the case in which the positive FE signal and the negative FE signal are measured at the local maximum point and the local minimum point of the FE signal, the present invention should not be limited to this structure. For example, the gain value of the balance circuit 40 may be set (the symmetry of the S-shape of the FE signal may be adjusted) in the manners (1) to (3) below.

(1) The prior-to-differentiation FE measurement unit 50 detects a local maximum value of the FE signal, and measures a signal level maxP1 of the positive FE signal and a signal level maxM1 of the negative FE signal corresponding to the local maximum value of the FE signal, and stores the measured signal level maxP1 of the positive FE signal and the measured signal level maxM1 of the negative FE signal.

(2) The prior-to-differentiation FE measurement unit 50 detects a local minimum value of the FE signal, and measures a signal level minP2 of the positive FE signal and a signal level minM2 of the negative FE signal corresponding to the local minimum value of the FE signal, and stores the measured signal level minP2 of the positive FE signal and the measured signal level minM2 of the negative FE signal.

(3) The prior-to-differentiation FE measurement unit 50 calculates an optimal gain value of the balance circuit 40 based on the four signal levels maxP1, maxM1, minP2, and minM2 obtained in the manners (1) and (2), and sets the calculated optimal gain value to be used by the balance circuit 40.

Although the present embodiment describes the case in which the device determines the level of the FE signal first using the level L301 and then using the level L302, the present invention should not be limited to this structure. For example, the device may determine the level of the FE signal first using the level L302 and then using the level L301. In this manner, the present invention may be applied to an FE signal having the polarity inverse to the polarity of the FE signal described in the present embodiment.

Alternatively, the optical disc device 300 may not determine the level of the FE signal using the levels L301 and L302, but may adjust the symmetry of the FE signal by detecting a local maximum point and a local minimum point of the FE signal.

The signal polarities of the positive FE signal and the negative FE signal may be inverse to the polarities described in the present embodiment.

The phase relationship between the positive FE signal and the negative FE signal may be inverse to the phase relationship described in the present embodiment.

Although the present embodiment describes the case in which the device adjusts the level of the positive FE signal at the local maximum point of the FE signal and the level of the negative FE signal at the local minimum point of the FE signal to be substantially the same level, the present invention should not be limited to this structure. For example, the device may adjust the symmetry of the FE signal by adjusting the level of the positive FE signal and the level of the negative FE signal in a manner that a difference between the level of the positive FE signal and the level of the negative FE signal at the local maximum point of the FE signal will be substantially the same as a difference between the level of the positive FE signal and the level of the negative FE signal at the local minimum point of the FE signal.

Although the present embodiment describes the case in which the balance circuit 40 that performs signal correction is arranged at the negative FE signal side, the present invention should not be limited to this structure. For example, the balance circuit 40 may be arranged at the positive FE signal side.

Alternatively, the balance circuit 40 may be arranged at each of the positive FE signal side and the negative FE signal side. In this case, the plurality-of-layer-average obtaining unit 71 adjusts the symmetry (symmetry of the S-shape) of an FE signal by setting the gain of a balance circuit arranged at the positive FE signal side and the gain of a balance circuit arranged at the negative FE signal side.

Although the present embodiment describes the case in which the calculated gain value is stored into memory, the present invention should not be limited to this structure. For example, the level of a positive FE signal and the level of a negative FE signal before a gain value to be used by the balance circuit 40 is calculated (the level of a positive FE signal and the level of a negative FE signal used to calculate a gain value) may be stored into memory, and gain calculation may be performed (gain values may be calculated) and the average of the gain values may be obtained based on the level of the positive FE signal and the level of the negative FE signal stored in the memory.

The optical disc 1 may have two or more information surfaces.

Although the present embodiment describes the case in which the average of gain values corresponding to all information surfaces of the optical disc 1 is obtained, the present invention should not be limited to this structure. For example, the average of gain values corresponding to selected two or more information surfaces of the optical disc 1 may be calculated, and two or more gain value averages may be obtained.

Although the present embodiment describes the case in which the average of gain values is obtained, the present invention should not be limited to this structure. For example, a gain value corresponding to a selected information surface of the optical disc 1 may be used as a gain value common to selected two or more information surfaces of the optical disc 1.

Although the present embodiment describes the case in which the average of gain values is obtained at a timing when driving of the objective lens 32 is switched from upward driving to downward driving, the present invention should not be limited to this structure. For example, the average of gain values may be obtained at a timing when gain values corresponding to selected two or more information surfaces of the optical disc 1 are calculated.

### Other Embodiments

Although the optical disc devices of the above embodiments perform processing using an FE signal obtained with an astigmatic method, the present invention should not be limited to this structure. Alternatively, the devices may use an FE signal obtained with other methods, such as a differential astigmatic method and a spot size detection method.

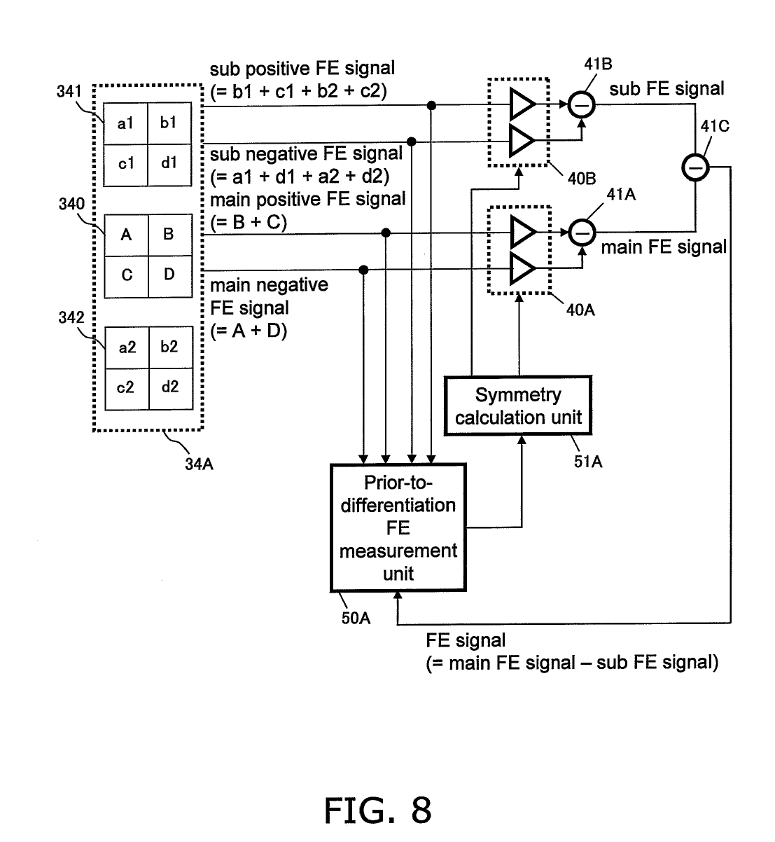

In one example, the optical disc device 100 of the first embodiment may use an FE signal obtained with a differential astigmatic method. The optical disc device 100 in this example will now be described with reference to FIG. 8.

FIG. 8 is a schematic diagram partially showing the structure of the optical disc device 100 of the first embodiment in the example in which the device uses an FE signal obtained with a differential astigmatic method. FIG. 8 shows a light receiving unit, a prior-to-differentiation FE measurement unit, a symmetry calculation unit, a balance adjustment unit (balance circuit), and a subtraction unit (differential circuit) included in the optical disc device 100.

As shown in FIG. 8, the light receiving unit 34A includes a main light receiving unit 340 and sub light receiving units 341 and 342. The main light receiving unit 340 obtains a main positive FE signal and a main negative FE signal. The sub light receiving units 341 and 342 obtain a sub positive FE signal and a sub negative FE signal. The main light receiving unit 340 and the sub light receiving units 341 and 342 obtain an FE signal with a differential astigmatic method. The main light receiving unit 34A mainly receives reflected light of the light spot that is on the track of the optical disc 1. The sub light receiving units 341 and 342 receive reflected light of the light spot that is at positions adjacent to the light spot received mainly by the main light receiving unit 34 in a direction intersecting with the track. The “positions adjacent to the light spot in the direction intersecting with the track” are only required to be positions intersecting with the track, and should not necessarily be positions intersecting with the track in the direction of the normal to the track. For example, such positions intend to include positions diagonally intersecting with the track.

As shown in FIG. 8, each of the main light receiving unit 340 and the sub light receiving units 341 and 342 is divided into four light receiving areas (four photodetectors). The main light receiving unit 340 includes an area A in which a light amount A is received, an area B in which a light amount B is received, an area C in which a light amount C is received, and an area D in which a light amount D is received.

The sub light receiving unit 341 includes an area a1 in which a light amount a1 is received, an area b1 in which a light amount b1 is received, an area c1 in which a light amount c1 is received, and an area d1 in which a light amount d1 is received.

The sub light receiving unit 342 includes an area a2 in which a light amount a2 is received, an area b2 in which a light amount b2 is received, an area c2 in which a light amount c2 is received, and an area d2 in which a light amount d2 is received.

The basic operation of the prior-to-differentiation FE measurement unit 50A is the same as the basic operation of the prior-to-differentiation FE measurement unit 50. The prior-to-differentiation FE measurement unit 50A differs from the prior-to-differentiation FE measurement unit 50 as shown in FIG. 8 in that its target signals are a main positive FE signal (=B+C), a main negative FE signal (=A+D), a sub positive FE signal (=b1+c1+b2+c2), and a sub negative FE signal (=a1+d1+a2+d2).

The basic operation of the symmetry calculation unit 51A is the same as the basic operation of the symmetry calculation unit 51. The symmetry calculation unit 51A differs from the symmetry calculation unit 51 in that its target signals are a main positive FE signal, a main negative FE signal, a sub positive FE signal, and a sub negative FE signal.

The symmetry calculation unit 51A performs balance adjustment of the main positive FE signal and the main negative FE signal and sets the gain value of the balance adjustment unit (balance circuit) 40A in the same manner as described in the above embodiments. The symmetry calculation unit 51A performs balance adjustment of the sub positive FE signal and the sub negative FE signal and sets the gain value of the balance adjustment unit (balance circuit) 40B in the same manner as described in the above embodiments.

The subtraction unit 41A obtains a main FE signal by performing the subtraction below using the main positive FE signal and the main negative FE signal output from the balance adjustment unit 40A:

Main FE signal=(main positive FE signal)−(main negative FE signal).

The subtraction unit 41A outputs the obtained main FE signal to the subtraction unit 41C.

The subtraction unit 41B obtains a sub FE signal by performing the subtraction below using the sub positive FE signal and the sub negative FE signal output from the balance adjustment unit 40B:

Sub FE signal=(sub positive FE signal)−(sub negative FE signal).

The subtraction unit 41B outputs the obtained sub FE signal to the subtraction unit 41C.

The subtraction unit 41C obtains an FE signal by performing the subtraction below:

FE signal=(main FE signal)−(sub FE signal).

As described above, the optical disc device 100 with the structure shown in FIG. 8 adjusts the symmetry of the S-shape of an FE signal in an appropriate manner using an FE signal obtained with a differential astigmatic method.

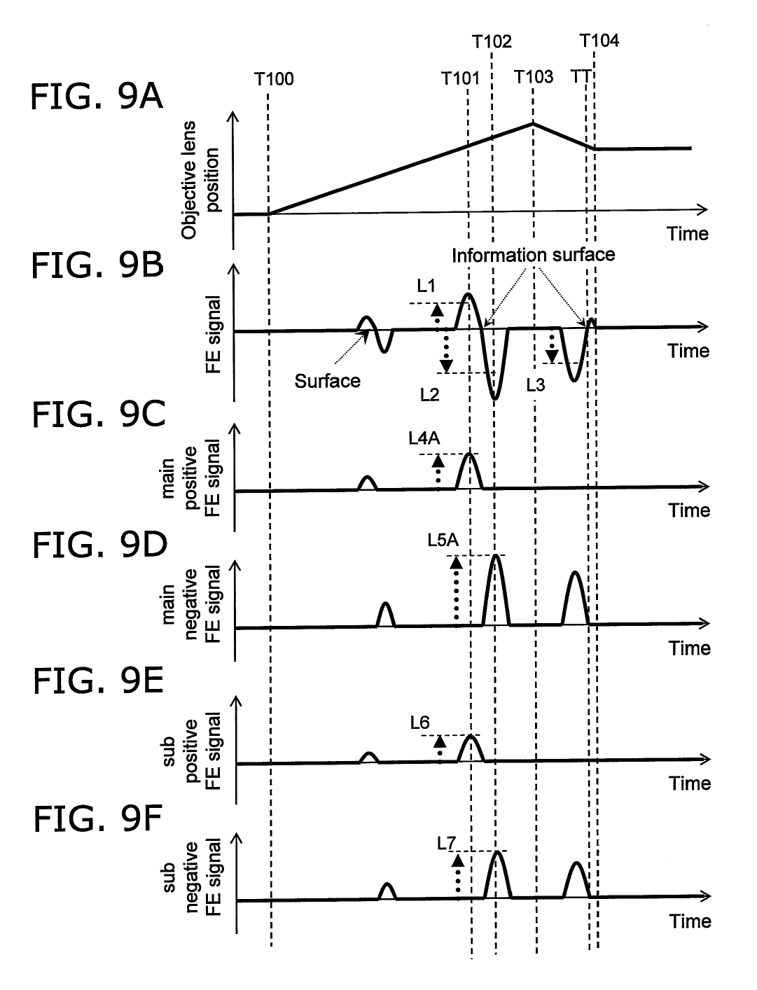

FIGS. 9A to 9F are signal waveform diagrams of the optical disc device 100 having the structure shown in FIG. 8 that adjusts the symmetry of the S-shape of an FE signal using an FE signal obtained with a differential astigmatic method. The waveform diagrams of

FIGS. 9A to 9F correspond to FIGS. 2A to 2D used in the first embodiment. Instead of the positive FE signal and the negative FE signal shown in FIGS. 2C and 2D, FIG. 9C shows the waveform of a main positive FE signal, FIG. 9D shows the waveform of a main negative FE signal, FIG. 9E shows the waveform of a sub positive FE signal, and FIG. 9F shows the waveform of a sub negative FE signal.

In the waveform diagrams of FIGS. 9C to 9F, the main positive FE signal has a signal level L4A at timing T101, the main negative FE signal has a signal level L5A at timing T102, the sub positive FE signal has a signal level L6 at timing T101, and the sub negative FE signal has a signal level L7 at timing T102.

In this example, the symmetry of the S-shape of an FE signal is adjusted using the same method as the method described with reference to FIGS. 2A to 2D, and the method for adjusting the symmetry of the S-shape of an FE signal will not be described in detail.

As described above, the device of the present invention may use an FE signal obtained with a differential astigmatic method.

The use of an FE signal obtained with a differential astigmatic method may also be applied to the above embodiments other than the first embodiment. The supplemental remarks in each of the above embodiments are also applicable to the example using an FE signal obtained with a differential astigmatic method (example described above).

Each block of the optical disc device in each of the above embodiments may be formed using a single chip with a semiconductor device, such as LSI (large-scale integration), or some or all of the blocks of the optical disc device may be formed using a single chip.

Although LSI is used as the semiconductor device technology, the technology may be IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks of the optical disc device. Biotechnology is potentially applicable.

The processes described in the above embodiments may be achieved using either hardware or software, or may be achieved using both software and hardware. When the optical disc device of each of the above embodiments is implemented by hardware, the optical disc device requires timing adjustment for each of its processes. For ease of explanation, timing adjustment associated with various signals required in an actual hardware design is not described in detail in the above embodiments.

The terms “substantially zero” and “substantially the same” used in the above embodiments intend to permit an error occurring when control or the like is executed using a target value (or a design value) of zero or using a target of being the same, or also permit an error determined depending on the resolution of the device, and “substantially zero” or “substantially the same” can include a range that a person skilled in the art determines (or recognizes) as being zero or being the same.

The specific structures described in the above embodiments are mere examples of the present invention, and may be changed and modified variously without departing from the scope and spirit of the invention.

### INDUSTRIAL APPLICABILITY

The present invention is applicable to an optical disc device that records and/or reads on an optical disc having an information surface and adjusts the symmetry of a focus error signal. The present invention is therefore useful and implementable in the optical disc-related industry.

1. An optical disc device that records and/or reads on an optical disc having an information surface, the device comprising:
an illumination unit operable to emit a light beam to the optical disc;
a converging unit operable to converge the light beam emitted from the illumination unit;
a focus drive unit operable to drive the converging unit in a manner to move a spot of the light beam that has been converged by the converging unit in a direction perpendicular to a disc surface of the optical disc;
a light receiving unit including a plurality of divisional detectors, and operable to receive reflected light from the optical disc using the plurality of divisional detectors and obtain, as a positive FE signal and a negative FE signal, an electric signal corresponding to an amount of the received light;
a measurement unit operable to measure a signal level of each of the positive FE signal and the negative FE signal obtained by the light receiving unit;
a signal correction unit operable to correct the signal level of at least one of the positive FE signal and the negative FE signal by multiplying the at least one of the positive FE signal and the negative FE signal by a predetermined gain value;
a focus error signal generation unit operable to generate a focus error signal based on an output from the signal correction unit, and output the generated focus error signal; and
a signal ratio calculation unit operable to obtain, based on an output from the measurement unit, the predetermined gain value by which the at least one of the positive FE signal and the negative FE signal is to be multiplied in a manner that the predetermined gain value causes an absolute value of a local maximum value of the focus error signal to be equal to an absolute value of a local minimum value of the focus error signal,
wherein the signal correction unit corrects the signal level of the at least one of the positive FE signal and the negative FE signal based on the predetermined gain value obtained by the signal ratio calculation unit.

2. The optical disc device according to claim 1,
wherein the signal ratio calculation unit obtains the predetermined gain value based on an output from the measurement unit at a point where a signal level of the focus error signal is at an extremum when the spot of the light beam is around a selected information surface of the optical disc or at a point where a signal level of each of the positive FE signal and the negative FE signal is at an extremum when the spot of the light beam is around a selected information surface of the optical disc.

3. The optical disc device according to claim 2, further comprising:
a focus control unit operable to control the spot of the light beam to be positioned on an information surface of the optical disc in accordance with a signal output from the focus error signal generation unit; and
a focusing unit operable to move the spot of the light beam in the direction perpendicular to the disc surface of the optical disc using the focus drive unit, and activate a control operation performed by the focus control unit when a position of the spot of the light beam agrees with a position on a selected information surface of the optical disc,
wherein the signal ratio calculation unit obtains the predetermined gain value to be used by the signal correction unit based on an output from the measurement unit at least once before the focusing unit activates the control operation performed by the focus control unit.

4. The optical disc device according to claim 2, further comprising:
a spherical aberration correction unit operable to correct a spherical aberration of the spot of the light beam on a selected information surface of the optical disc,
wherein the signal ratio calculation unit obtains the predetermined gain value to be used by the signal correction unit based on an output from the measurement unit after the spherical aberration is corrected by the spherical aberration correction unit.

5. The optical disc device according to claim 4, further comprising:
a focus control unit operable to control the spot of the light beam to be positioned on an information surface of the optical disc in accordance with a signal output from the focus error signal generation unit; and
a focusing unit operable to move the spot of the light beam in a direction perpendicular to the disc surface of the optical disc using the focus drive unit, and activate a control operation performed by the focus control unit when a position of the spot of the light beam agrees with a position on a selected information surface of the optical disc,
wherein the signal ratio calculation unit obtains the predetermined gain value to be used by the signal correction unit based on an output from the measurement unit when the spot of the light beam is moved toward the optical disc using the focusing unit, and
the focusing unit executes focus control using the focus control unit in a manner that the spot of the light beam is positioned on a selected information surface of the optical disc after the predetermined gain value is obtained by the signal ratio calculation unit.

6. The optical disc device according to claim 4, further comprising:
a disc determination unit operable to perform an operation of moving the spot of the light beam toward the optical disc and an operation of moving the spot of the light beam away from the optical disc using the focus drive unit to determine a type of the optical disc mounted on the device,
wherein the signal ratio calculation unit obtains the predetermined gain value to be used by the signal correction unit based on an output from the measurement unit during at least one of the operation of moving the spot of the light beam toward the optical disc and the operation of moving the spot of the light beam away from the optical disc performed by the disc determination unit.

7. The optical disc device according to claim 6, further comprising:
a signal ratio optimization unit operable to obtain, as a first gain value, the predetermined gain value obtained by the signal ratio calculation unit during the operation of moving the spot of the light beam toward the optical disc, and obtain, as a second gain value, the predetermined gain value obtained by the signal ratio calculation unit during the operation of moving the spot of the light beam away from the optical disc, and obtain the predetermined gain value to be used by the signal correction unit based on the first gain value and the second gain value.

8. The optical disc device according to claim 1, wherein when the optical disc has a plurality of information surfaces,
the signal ratio calculation unit obtains, for each of all the information surfaces, the predetermined gain value to be used by the signal correction unit based on a signal output from the measurement unit at a point where a signal level of the focus error signal is at an extremum when the spot of the light beam is around each information surface of the optical disc or at a point where a signal level of each of the positive FE signal and the negative FE signal is at an extremum when the spot of the light beam is around each information surface of the optical disc.

9. The optical disc device according to claim 8, further comprising:
a focus control unit operable to control the spot of the light beam to be positioned on an information surface of the optical disc in accordance with a signal output from the focus error signal generation unit; and
a focusing unit operable to move the spot of the light beam in the direction perpendicular to the disc surface of the optical disc using the focus drive unit, and activate a control operation performed by the focus control unit when a position of the spot of the light beam agrees with a position on a selected information surface of the optical disc,
wherein the signal ratio calculation unit obtains the predetermined gain value to be used by the signal correction unit based on an output from the measurement unit at least once before the focusing unit activates the control operation performed by the focus control unit.

10. The optical disc device according to claim 8, further comprising:
a focus control unit operable to control the spot of the light beam to be positioned on an information surface of the optical disc in accordance with a signal output from the focus error signal generation unit; and
a focusing unit operable to move the spot of the light beam in the direction perpendicular to the disc surface of the optical disc using the focus drive unit, and activate a control operation performed by the focus control unit when a position of the spot of the light beam agrees with a position on a selected information surface of the optical disc,
wherein the signal ratio calculation unit obtains the predetermined gain value to be used by the signal correction unit based on an output from the measurement unit when the spot of the light beam is moved toward the optical disc using the focusing unit, and
the focusing unit executes focus control using the focus control unit in a manner that the spot of the light beam is positioned on a selected information surface of the optical disc after the predetermined gain value is obtained by the signal ratio calculation unit.

11. The optical disc device according to claim 8, further comprising:
a disc determination unit operable to perform an operation of moving the spot of the light beam toward the optical disc and an operation of moving the spot of the light beam away from the optical disc using the focus drive unit to determine a type of the optical disc mounted on the optical disc device,
wherein the signal ratio calculation unit obtains the predetermined gain value to be used by the signal correction unit based on an output from the measurement unit during at least one of the operation of moving the spot of the light beam toward the optical disc and the operation of moving the spot of the light beam away from the optical disc performed by the disc determination unit.

12. The optical disc device according to claim 11, further comprising:
a signal ratio optimization unit operable to obtain, as a first gain value, the predetermined gain value obtained by the signal ratio calculation unit during the operation of moving the spot of the light beam toward the optical disc, and obtain, as a second gain value, the predetermined gain value obtained by the signal ratio calculation unit during the operation of moving the spot of the light beam away from the optical disc, and obtain the predetermined gain value to be used by the signal correction unit based on the first gain value and the second gain value.

13. The optical disc device according to claim 8, further comprising:
a spherical aberration correction unit operable to correct a spherical aberration of the spot of the light beam during at least one of the operation of moving the spot of the light beam toward the optical disc and the operation of moving the spot of the light beam away from the optical disc performed by the focus drive unit when the spot of the light beam passes through each of all the information surfaces of the optical disc, wherein the spherical aberration correction is performed in parallel with the operation performed by the focus drive unit in a manner to reduce the spherical aberration of the spot of the light beam to substantially zero on a selected information surface through which the spot of the light beam passes.

14. The optical disc device according to claim 8, further comprising:
a spherical aberration correction unit operable to correct a spherical aberration of the spot of the light beam on a selected information surface of the optical disc; and
an each-layer signal ratio calculation unit operable to perform processing of first activating an operation of the spherical aberration correction unit on a selected information surface of the optical disc and then activating an operation of obtaining the predetermined gain value performed by the signal ratio calculation unit during at least one of the operation of moving the spot of the light beam toward the optical disc and the operation of moving the spot of the light beam away from the optical disc performed by the focus drive unit, wherein the each-layer signal ratio calculation unit performs the processing for each of all the information surfaces of the optical disc.

15. The optical disc device according to claim 1 that records and/or reads on an optical disc having a plurality of information surfaces, the device further comprising:
a plurality-of-information-surface signal ratio calculation unit operable to calculate, as the predetermined gain value to be used by the signal correction unit, a common gain value that is used commonly for the plurality of information surfaces of the optical disc,
wherein the signal ratio calculation unit obtains a plurality of predetermined gain values for the plurality of information surfaces, and
the plurality-of-information-surface signal ratio calculation unit obtains the common gain value based on the plurality of predetermined gain values for the plurality of information surfaces that are obtained by the signal ratio calculation unit.

16. The optical disc device according to claim 15, further comprising:
a focus control unit operable to control the spot of the light beam to be positioned on an information surface of the optical disc in accordance with a signal output from the focus error signal generation unit; and
a focusing unit operable to move the spot of the light beam in a direction perpendicular to the disc surface of the optical disc using the focus drive unit, and activate a control operation performed by the focus control unit when the spot of the light beam is positioned on a selected information surface of the optical disc,
wherein the plurality-of-information-surface signal ratio calculation unit obtains the common gain value based on an output from the measurement unit at least once before the focusing unit activates the control operation performed by the focus control unit.

17. A focus error signal adjusting method used in an optical disc device that records and/or reads on an optical disc having an information surface and includes
an illumination unit operable to emit a light beam to the optical disc,
a converging unit operable to converge the light beam emitted from the illumination unit,
a focus drive unit operable to drive the converging unit in a manner to move a spot of the light beam that has been converged by the converging unit in a direction perpendicular to a disc surface of the optical disc, and
a light receiving unit including a plurality of divisional detectors, and operable to receive reflected light from the optical disc using the plurality of divisional detectors and obtain, as a positive FE signal and a negative FE signal, an electric signal corresponding to an amount of the received light,
the method comprising:
measuring a signal level of each of the positive FE signal and the negative FE signal obtained by the light receiving unit;
correcting the signal level of at least one of the positive FE signal and the negative FE signal by multiplying the at least one of the positive FE signal and the negative FE signal by a predetermined gain value;
generating a focus error signal based on an output from the signal correction unit, and outputting the generated focus error signal; and
obtaining, based on an output in the measurement step, the predetermined gain value by which the at least one of the positive FE signal and the negative FE signal is to be multiplied in a manner that the predetermined gain value causes an absolute value of a local maximum value of the focus error signal to be equal to an absolute value of a local minimum value of the focus error signal,
wherein in the signal correction step, the signal level of the at least one of the positive FE signal and the negative FE signal is corrected based on the predetermined gain value obtained in the signal ratio calculation step.

18. A program enabling a computer to implement a focus error signal adjusting method used in an optical disc device that records and/or reads on an optical disc having an information surface and includes
an illumination unit operable to emit a light beam to the optical disc,
a converging unit operable to converge the light beam emitted from the illumination unit,
a focus drive unit operable to drive the converging unit in a manner to move a spot of the light beam that has been converged by the converging unit in a direction perpendicular to a disc surface of the optical disc, and
a light receiving unit including a plurality of divisional detectors, and operable to receive reflected light from the optical disc using the plurality of divisional detectors and obtain, as a positive FE signal and a negative FE signal, an electric signal corresponding to an amount of the received light,
the method comprising:
measuring a signal level of each of the positive FE signal and the negative FE signal obtained by the light receiving unit;
correcting the signal level of at least one of the positive FE signal and the negative FE signal by multiplying the at least one of the positive FE signal and the negative FE signal by a predetermined gain value;
generating a focus error signal based on an output from the signal correction unit, and outputting the generated focus error signal; and
obtaining, based on an output in the measurement step, the predetermined gain value by which the at least one of the positive FE signal and the negative FE signal is to be multiplied in a manner that the predetermined gain value causes an absolute value of a local maximum value of the focus error signal to be equal to an absolute value of a local minimum value of the focus error signal,
wherein in the signal correction step, the signal level of the at least one of the positive FE signal and the negative FE signal is corrected based on the predetermined gain value obtained in the signal ratio calculation step.

19. An integrated circuit used in an optical disc device that records and/or reads on an optical disc having an information surface and includes
an illumination unit operable to emit a light beam to the optical disc,
a converging unit operable to converge the light beam emitted from the illumination unit,
a focus drive unit operable to drive the converging unit in a manner to move a spot of the light beam that has been converged by the converging unit in a direction perpendicular to a disc surface of the optical disc, and
a light receiving unit including a plurality of divisional detectors, and operable to receive reflected light from the optical disc using the plurality of divisional detectors and obtain, as a positive FE signal and a negative FE signal, an electric signal corresponding to an amount of the received light,
the integrated circuit comprising:
a measurement unit operable to measure a signal level of each of the positive FE signal and the negative FE signal obtained by the light receiving unit;
a signal correction unit operable to correct the signal level of at least one of the positive FE signal and the negative FE signal by multiplying the at least one of the positive FE signal and the negative FE signal by a predetermined gain value;
a focus error signal generation unit operable to generate a focus error signal based on an output from the signal correction unit, and output the generated focus error signal; and
a signal ratio calculation unit operable to obtain, based on an output from the measurement unit, the predetermined gain value by which the at least one of the positive FE signal and the negative FE signal is to be multiplied in a manner that the predetermined gain value causes an absolute value of a local maximum value of the focus error signal to be equal to an absolute value of a local minimum value of the focus error signal,
wherein the signal correction unit corrects the signal level of the at least one of the positive FE signal and the negative FE signal based on the predetermined gain value obtained by the signal ratio calculation unit.
